(19) United States
(12) Patent Application Publication
(10) Pub. No.: US 2011/0305887 A1
(43) Pub. Date: Dec. 15, 2011

(54) Laminates Formed In Part from Laminate Enhancing Agents

(75) Inventor: Andreas M. Gottzmann, Agawam, MA (US)

(73) Assignee: Suddekor, LLC, Agawam, MA (US)

(21) Appl. No.: 13/155,718

(22) Filed: Jun. 8, 2011

Related U.S. Application Data
(60) Provisional application No. 61/353,371, filed on Jun. 10, 2010.

(51) Int. Cl. B32B 5/16; B32B 3/10; C09J 5/04; B05D 3/02; B32B 38/08; B32B 38/14

(52) U.S. Cl. 428/206; 156/182; 156/273.3; 156/277; 156/315; 427/379; 427/387; 428/323; 428/325; 428/327; 428/447

(57) ABSTRACT

A laminate having improved clarity and abrasion-resistant, scuff-, mar- and impact resistance, said laminate comprising an overlay and/or a décor layer formed via the application of a slurry to a respective substrate and/or décor sheet, wherein the slurry comprises a silicone based thermoplastic resin and a mix of laminate enhancing agents comprising cylindrical, fiber-shaped laminate enhancing agents which may or may not be coated with silicone powder or liquid comprising at least one of glass, ceramic, and plastic. The décor layer may alternatively or additionally be formed in part via the application of a mix of laminate enhancing agents and/or the slurry at the printing stage of the décor sheet.

### CROSS REFERENCE TO RELATED APPLICATIONS

This application claims the benefit of U.S. Provisional Application No. 61/353,371 filed on Jun. 10, 2010.

### BACKGROUND OF THE INVENTION

1. Field of the Invention

The present invention relates to laminates. More particularly, the invention relates to a laminate formed in part from a slurry comprising a thermoplastic resin and a mix of a variety of different shaped and coated laminate enhancing agents, and to novel processes for forming the inventive laminate.

2. Background

Decorative laminates are well-known and used, for instance, as covering material for walls, cupboard doors, desktops, tabletops, and other furniture; as flooring material; etc. Such laminates are often made of a décor sheet sandwiched between a core and an overlay.

The core typically comprises a plurality of conventional dry or treated thermosetting resin-impregnated prepregs of continuous paper or sheets respectively. The resin in the uppermost of these continuous papers or sheets typically comprises a thermosetting resin such as a melamine-formaldehyde resin, while the rest of the continuous papers or sheets typically comprises a thermosetting resin such as phenol-formaldehyde resin or phenol-urea-formaldehyde resin. The continuous papers or pile of sheets are laminated continuously or discontinuously respectively with the décor sheet and the overlay at a high pressure and an increased temperature. Alternatively, the core may comprise particle board or fiber board, whereby the overlay and the décor sheet may be bonded to the core by gluing or laminating under heat and pressure.

The décor sheet may be either monochromatic or patterned, and is typically formed from paper. Furthermore, The décor sheet is typically impregnated with a melamine-formaldehyde resin.

The overlay is intended to protect the décor sheet from scratching, abrasion, scuffing and marring. Overlays have been used over decorative surfaces for years to provide protection against wear and tear. The principal technology for the high-pressure laminate (HPL) industry has been to use an overlay that is pre-loaded during the paper making process with alumina-based particles, wherein such particles confer wear and abrasion resistance properties onto the overlay. After the alumina-based particles are mixed with the paper fibers during the paper making process, the preloaded overlay is then impregnated with thermoset resin and is pressed under heat and pressure with the core and the decorative components to create the laminate.

This method, however, has proven inadequate in obtaining laminates having ideal characteristics. This is because the alumina-based particles are spread and distributed over a layer of wet alpha-cellulose fibers by a wire on a paper machine in a more or less irregular manner within the whole fiber layer. Some of these particles even pass through the wire. Thus, the alumina-based particles are distributed in an uncontrolled or random way on the overlay. It is very difficult by this known method to achieve an even distribution of the particles on the surface of the paper. As the best effect against abrasion (scuff and mar) of the surface in the finished product is achieved as a result of an even distribution of particles, in the present state of the art, the laminates obtained containing such an overlay will provide uneven quality regarding abrasion resistance.

However, recently in the field of art, a process has been developed whereby the particles are applied to the overlay during the impregnation process rather than during the paper making process. This process is called liquid overlay. In this process, a continuous web of alpha cellulose paper is impregnated with thermoset resin, and is then coated with a slurry comprising alumina-based particles and a thermoset resin. The liquid overlay process creates an overlay, which, when pressed, has far superior clarity to that of the preloaded overlay formed by the process discussed above. Clarity is desirable because it allows the decorative layer underneath the overlay to show through clearly, and the overall color of the laminate is, therefore, closer to the color that the designer of the decorative layer intended.

Despite this improvement, however, there remains the need to improve additional characteristics of the laminate and the process of manufacturing the laminate, This is especially the case with laminates for floors, desktops, and tabletops, and other furniture.

In addition, in the present state of the art, the use of alumina-based particles in the formation of the overlay decreases the, clarity of the decorative layer under the overlay, thereby causing the laminate to appear cloudy. Accordingly, the decorative design is not clearly visible through the laminate. This cloudy look is caused by the fact that the alumina-based particles are on the paper when the paper is introduced to the resin. The resin does not have sufficient saturation time to encapsulate each particle; accordingly, air pockets, which distort the light and cause the milky, cloudy look, are created around the alumina-based particles.

In addition, in the present state of the art, whereby alumina-based particles are used in the formation of the overlay, the damage to or denting of the surface caused by the impact of an object on the surface is increased. This decreased impact resistance is caused by the relatively flat orientation of the alumina-based particles on the overlay.

It would additionally be beneficial to create a laminate having increased impact resistance properties without the need for an overlay, thereby also increasing the overall clarity of the laminate.

In addition, during the manufacturing process, with alumina-based particles, the press plates on the machinery used in manufacturing the laminate suffer wear and must be replaced often.

### SUMMARY OF THE INVENTION

The above-described deficiencies of the prior art are overcome by creating a laminate comprising an overlay and/or a décor layer formed without or with a reduced amount of alumina to increase the clarity of the décor layer in the final laminate product. To that end, a silicone-based thermoset resin has been produced for use in the formation of the overlay and/or the décor layer of the laminate product.

In an exemplary embodiment, an exemplary overlay may be formed by impregnating a substrate with a thermosetting resin comprised of silicone and coating the substrate with a slurry comprising a thermoset resin comprised of silicone and a mix of laminate enhancing agents, wherein the mix of laminate enhancing agents comprises a percentage of platelet shaped cylindrical, fiber-like shaped particles comprising at least one or more of glass, ceramic, plastic, and the like, and further wherein the percentage of platelet, cylindrical or fiber-like shaped particles used to form the overlay is based upon desired a clarity and/or based upon a desired scuff and mar resistance. The resulting overlay demonstrates superior properties of wear performance, clarity, scuff resistance, scratch resistance, mar resistance, abrasion resistance and impact resistance. Additionally, to further enhance the above-stated characteristics, the overlay may be formed with additional thermosetting resin layers comprised of silicone, wherein the additional thermosetting resin layers are applied to the composite after the composite containing the thermoset resin and the slurry is cured.

The present disclosure further supports a process for the formation of a novel décor layer, which may be used to form a laminate without the additional need for an overlay. In an exemplary embodiment, the décor layer may be formed by impregnating a conventional décor sheet with a silicone-containing thermosetting resin composition and then coating the impregnated décor sheet with a slurry comprising a silicone-containing thermoset resin composition and a mix of laminate enhancing agents to form a décor layer. Additionally or alternatively, the décor sheet may be treated with a mix of laminate enhancing agents at the printing stage of the formation of the décor sheet and, hence, prior to impregnation of the décor sheet with a thermoplastic resin. The mix of laminate enhancing agents comprises a percentage of platelet, cylindrical, fiber-like shaped particles comprising at least one or more of glass, ceramic, plastic, and the like, wherein the percentage of platelet, cylindrical, fiber-like shaped particles used to form the décor sheet is based upon a desired clarity and/or based upon a desired scuff and mar resistance. The décor layer, which comprises the platelet, cylindrical, fiber-like shaped particles, may be laminated to a core to form a laminate having superior properties of wear performance, clarity, scuff resistance, scratch resistance, mar resistance, and abrasion resistance.

Both the overlay and the décor layer disclosed herein may be formed via liquid overlay technology. The process used to form the overlay and the décor layer, which comprises applying either a mix of laminate enhancing agents or a silicone slurry comprising the laminate enhancing agents to the décor sheet at the printing stage, or the silicone slurry to the overlay substrate and/or to the décor sheet at the treating stage, creates a laminate that, when pressed, has superior clarity and abrasion-, scuff-, mar- and impact resistance as compared to prior art laminates formed by conventional processes.

Alternatively or in addition, the laminate enhancing agents may be coated with a powder silicone or a liquid silicone prior to introducing the laminate enhancing agents into the resin.

Silicone may be utilized in lieu of or in addition to aluminum oxide in the slurry. Alternatively or in addition, silicone powder may be used to coat the platelet, cylindrical, fiber-like shaped particles, utilized as additives. Silicone in cross-linked compositions wherein the molecules are linked together is preferred for this function.

The silicone disclosed herein is preferred due to its properties. The disclosed silicone is any of a diverse class of polymers manufactured as fluids, resins or elastomers. They are partially organic compounds, but, unlike most polymers, they have a backbone containing no carbon, composed instead of alternating silicon and oxygen atoms. In most silicones, two organic groups usually methyl or phenyl, are attached to each silicon atom. Silicones in general are exceptionally stable and inert.

In terms of composition, atoms of silicon and oxygen alternate in a chain; various organic radicals, such as the methyl group CH₃, are bound to the silicon atoms. Silicones, which are unusually stable at extreme temperatures (both high and low), may occur as liquids, rubbers, resins, or greases. Silicones are prepared from halides of organic silicon compounds by decomposition. Such compounds are chosen and used in mixtures that allow the desired molecular weight and degree of cross-linking to be obtained in the final polymer. Water repellent, chemically inert, and stable at extreme temperatures, silicones are used as protective coatings and electrical insulators and in caulk.

In the present invention, the use of silicone in the formation of the overlay and/or the décor layer can eliminate and/or greatly reduce the amount of formaldehyde-based resins used to form the overlay and/or the décor layer, thereby enhancing the wear life of the press plates, and reducing and/or eliminating the use of formaldehyde in the manufacturing process.

### BRIEF DESCRIPTION OF THE DRAWINGS

FIG. 1 is a schematic depicting an exemplary process for forming an overlay;

FIG. 2 is a schematic depicting an exemplary overlay formed from the process depicted in FIG. 1;

FIG. 3 is another schematic depicting an exemplary process for forming an overlay;

FIGS. 4-7 are schematics depicting exemplary overlays formed from the process depicted in FIG. 3;

FIG. 8 is a schematic depicting an exemplary process for forming a laminate;

FIG. 9 is a schematic depicting an exemplary laminate formed from the process set forth in FIG. 8;

FIG. 10 is a photograph of prior art laminate enhancing agents;

FIG. 11 is a photograph of exemplary cylindrical, fiber-like laminate enhancing agents;

FIG. 12 is a schematic depicting an exemplary process for forming an exemplary décor layer comprising coating the décor sheet with a slurry comprising a mix of laminate enhancing agents at a treating stage of a décor sheet;

FIG. 13 is a schematic depicting an exemplary process for forming an exemplary décor layer comprising adding a slurry comprising a mix of laminate enhancing agents to a décor sheet at a printing stage of the décor sheet;

FIG. 14 is a schematic depicting an exemplary process for forming an exemplary décor layer comprising adding a mix of laminate enhancing agents to a décor sheet at a printing stage of the décor sheet;

FIG. 15 is a schematic depicting an exemplary process for forming an exemplary décor layer comprising coating a décor sheet with the slurry at both the printing stage and at the treating stage;

FIG. 16 is a schematic depicting an exemplary process for forming an exemplary décor layer comprising coating a décor sheet with a mix of laminate enhancing agents at the printing stage, and further comprising coating the décor sheet with the slurry at the treating stage;

FIG. 17 is a schematic depicting an exemplary décor layer formed from the processes depicted in FIGS. 12-16;

FIG. 18 is a schematic depicting an exemplary process for forming another exemplary décor layer at a treating stage of a décor sheet;

FIG. 19 is a schematic depicting an exemplary process for forming another exemplary décor layer comprising adding a slurry comprising a mix of laminate enhancing agents to a décor sheet at a printing stage of the décor sheet;

FIG. 20 is a schematic depicting an exemplary process for forming another exemplary décor layer comprising adding a mix of laminate enhancing agents to a décor sheet at a printing stage of the décor sheet;

FIG. 21 is a schematic depicting an exemplary process for forming another exemplary décor layer comprising coating a décor sheet with the slurry at both the printing stage and at the treating stage;

FIG. 22 is a schematic depicting an exemplary process for forming another exemplary décor layer comprising coating a décor sheet with a mix of laminate enhancing agents at the printing stage, and further comprising coating the décor sheet with the slurry at the treating stage;

FIG. 23-26 are schematics depicting exemplary décor layers formed from the processes depicted in FIGS. 18-22;

FIGS. 27-31 are schematics each depicting an exemplary process for forming a laminate with an overlay and a décor layer, wherein both the overlay and the décor layer are treated with laminate enhancing agents;

FIGS. 32-36 are schematics each depicting an exemplary process for forming a laminate with an overlay, wherein the décor sheet is treated with laminate enhancing agents, and the overlay is not treated with such laminate enhancing agents;

FIGS. 37-41 are schematics each depicting an exemplary process for forming a laminate without an overlay;

FIG. 42 is a schematic depicting an exemplary laminate formed from the processes set forth in FIGS. 27-31;

FIG. 43 is a schematic depicting an exemplary laminate formed from the processes set forth in FIGS. 32-36;

FIG. 44 is a schematic depicting an exemplary laminate formed from the processes set forth in FIGS. 37-41; and

FIG. 45 is a schematic depicting an exemplary process for applying a slurry to an exemplary overlay, wherein the process is equally applicable to the application of the slurry or of the mix of laminate enhancing agents to a décor sheet either at the printing stage or at the treating stage of the décor sheet.

### DETAILED DESCRIPTION OF THE INVENTION

The present invention is aimed at forming a laminate having improved properties of wear performance, clarity, scuff resistance scratch resistance, mar resistance, abrasion resistance, and impact resistance and, in the manufacturing process, effective in decreasing wear to the press plates. More particularly, the laminate may comprise a décor layer and/or an overlay formed from silicone-containing thermoset resins, wherein such resins may replace the need for traditionally used alumina-containing thermoset resins and/or formaldehyde-containing thermoset resins, thereby improving the clarity of the laminate, improving the wear performance of the laminate, improving the scuff and mar resistance of the laminate, and reducing plate wear.

Such an improved laminate may comprise an overlay formed by impregnating a substrate with a silicone-containing thermoset resin, and then by coating the impregnated substrate with a slurry, wherein the slurry comprises a silicone-containing thermoset resin and a mix of laminate enhancing agents, which include platelet, cylindrical, fiber-like agents formed from materials comprising, for example, at least one of glass, plastic, ceramic, and the like. As will be discussed in further detail below, the laminate enhancing agents may further include silicone coated or silicone based particles to improve the scuff resistance and mar resistance of laminate overlays. The resulting composite may then be cured to form a cured composite. The process may further comprise applying at least one or more additional silicone-containing thermoset resin layers to the cured composite.

The substrate may comprise conventional laminate overlay substrates. Accordingly, the substrate may include, for example and without limitation, at least one of paper, glass, mica, and the like, and may comprise one or multiple layers of these materials.

The silicone-containing thermoset resin(s) used to impregnate the substrate, the silicone-containing thermoset resin(s) used to form the slurry, and the silicone-containing thermoset resin(s) used to form the additional silicone-containing thermoset resin layers, may comprise a wide variety of thermoset resin compositions, and may be identical to or different from each other in composition. The thermoset resin may include silicone powder or liquid or silicone coated particles in lieu of those thermoset resins which are conventional in the laminate industry. Additionally, the use of any size and shape of silicone particles may be used to form the silicon-containing thermoset resin.

The thermoset resin may include low pressure formulations and high pressure formulations depending on whether low pressure laminates or high pressure laminates are desired. In general, high pressure formulations have a low mole ratio and low pressure formulations have a high mole ratio, wherein the mole ratio may vary widely and constitutes the proportion between the concentration of the cross linking agent, for example, the silicone, and the concentration of the thermoset agent, e.g., the melamine, in the thermoset resin, wherein the mole ratio is selected to confer certain desired characteristics onto the laminate based on the use of the laminate.

Additionally, the silicone-containing thermoset resin used in the process disclosed herein may comprise certain additives to increase certain desired properties. For example, the additives may comprise at least one of plasticizers which control the flexibility of the surface layer, saturation agents which promote clarity, catalysts which control flexibility and aid in the curing of the surface layer, release agents which assist in production, antiblock agents which reduce blocking or sticking, and the like. The additives may be added at various points in the process disclosed herein.

As previously stated, the slurry, which is preferably coated on the silicone-containing thermoset resin that impregnates the substrate of the overlay, comprises a silicone-containing thermoset resin and a mix of laminate enhancing agents, wherein the laminate enhancing agents include platelet, cylindrical, fiber-like shaped laminate enhancing agents, which may be coated with a silicone-based powder and/or a silicone-based liquid. As stated above, the thermoset resin in the slurry may comprise those thermoset resins described above, wherein the thermoset resin that impregnates the substrate may comprise a composition that is identical to or different from the thermoset resin in the slurry with regards to both the specific agents used in the composition and the quantities of agents used in the composition.

The platelet, cylindrical, fiber-like shaped laminate enhancing agents may comprise a variety of materials, wherein exemplary materials include, for example and without limitation, at least one of glass, silica, silicon carbide, a ceramic, a plastic (such as, for example, one or more of polyethylene, polypropylene, and the like), and the like, wherein laminate enhancing agents comprising at least one of glass, a ceramic, and a plastic are especially preferred and may be coated with silicone powder. Additionally, the platelet, cylindrical, fiber-like shaped laminate enhancing agents may be sized or unsized, wherein when sized, they are preferably coated with saline and cationic agents and may be coated with silicone powder or liquid.

In addition to the material used to form the platelet, cylindrical, fiber-like shaped laminate enhancing agents, the geometrical shape of the laminate enhancing agents is also important in conferring the desired properties of clarity, scratch resistance, mar resistance, abrasion resistance, and impact resistance onto the final laminate product. The length of the platelet, cylindrical, fiber-like shaped agents forming the mix of laminate enhancing agents is longer than the diameter of the particles. Thus the agents are fiber-like. In an exemplary embodiment, the platelet, cylindrical, fiber-like shaped laminate enhancing agents comprise particles having a diameter of about 1 micrometer to about 100 micrometers, and a length of about 2 micrometers to about 500 micrometers. Additionally, in an exemplary embodiment, the platelet, cylindrical, fiber-like shaped laminate enhancing agents forming the mix are selected such that there is diversity in the overall length of the platelet, cylindrical, fiber-like shaped laminate enhancing agents forming the mix. Additionally, to achieve diversity in the length of the cylindrical, fiber-shaped laminate enhancing agents, the particles may be cut at an angle.

For purposes of clarification, a prior art alumina-based laminate enhancing agent is depicted in FIG. 10 as compared to an exemplary platelet, cylindrical, fiber-like shaped silicone powder coated laminate enhancing agent of the present invention which is depicted in FIG. 11. When used in conventional overlays, conventionally used laminate enhancing particles are crystalline or spherical in shape (see, for example, FIG. 10). When pressed, the crystalline or spherical shapes leave high points on the surface of the laminate. However, the platelet, cylindrical, fiber-like shaped laminate enhancing agents of the present invention produce a smoother, flatter surface when pressed, as such particles tend to lie flat on the substrate during the pressing stage. This smooth surface increases the clarity, and the scratch- and mar-resistance of the overlay.

Additionally, the platelet, cylindrical, fiber-like shape of the platelet, cylindrical, fiber-like shaped laminate enhancing agents is optically superior to the spherical fused type-shape of laminate enhancing agents which are depicted in FIG. 10. In an exemplary embodiment, the fiber-shaped laminate enhancing agents have an aspect ratio of about 2:1 to about 25:1, meaning that the cylindrical, fiber-shaped particles are long, fiber-like and thin. Thus it is easier to see through the fiber-like type of laminate enhancing agents as compared to conventionally used spherical type-shaped particles.

Furthermore, the silicone powder coating of the laminate enhancing agents can also have an impact on press plate life. The standard spherical particles used in conventional overlays have more potential to cause premature press plate wear when the overlay is pressed as the prior art uncoated particles can act like sandpaper. The silicone coated laminate enhancing agents in the overlay of the present invention, however, wherein such agents are preferably within the range of about 1 micrometer to about 100 micrometers in diameter and about 2 micrometers to about 500 micrometers in length, have less potential to cause premature press plate wear. Additionally, a larger variation in length and diameter as well as the silicone coating of the fibers provides a greater cushion against press plates and less potential to cause premature plate wear.

Despite the benefits of having platelet, cylindrical, fiber-like shaped laminate enhancing agents randomly oriented onto the substrate when pressed, if additional wear resistance is desired, the mix of silicone powder coated laminate enhancing agents may further comprise crystalline shaped laminate enhancing agents, wherein it is contemplated that an unlimited matrix of combinations of shapes, sizes and concentrations of laminate enhancing agents may be used to obtain the desired characteristics in the final product. Such silicone coated crystalline shaped laminate enhancing agents may comprise, for example, at least one of alumina, silica carbide, silicon, glass, ceramic, plastic, and the like, wherein alumina is especially preferred. However, in an exemplary embodiment, it is contemplated that the mix may comprise at least about 5 percent of silicone coated platelet, cylindrical, fiber-like shaped laminate enhancing agents, wherein the percentage is based on the total number of laminate enhancing agents contained in the mix which forms, at least in part, the slurry. Other additives, such as cellulose and/or glass beads may be added to the slurry and may be coated with silicone powder to further protect the press plates from wear.

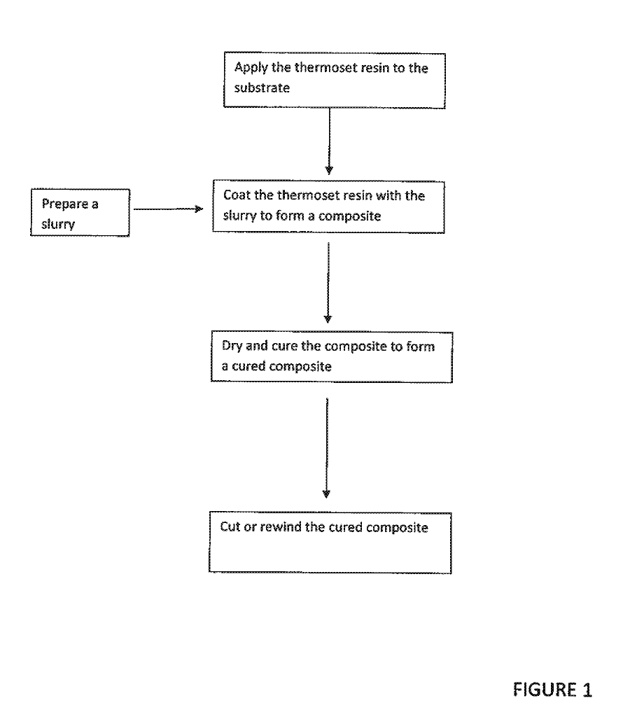

An exemplary process used to form the inventive overlay and laminate of the present invention is discussed with reference to FIG. 1. Referring to FIG. 1, an exemplary process comprises preparing a slurry comprising a mix of laminate enhancing agents. The concentration of the mix of laminate enhancing agents in the slurry is preferably from about 1 percent to about 50 percent, based on the total concentration of the slurry, wherein at least about 5 percent of the laminate enhancing agents in the mix have a platelet, cylindrical, fiber-like configuration and are formed from at least one of, for example, glass, ceramic, plastic, and the like, wherein the percentage is based on the total number of laminate enhancing agents contained in the mix in the slurry.

The process may further comprise applying a silicone-containing thermoset resin to a substrate, and then applying the slurry to the substrate while the substrate is still wet from the application of the silicone-containing thermoset resin. In an exemplary embodiment, silicone particles, which form, at least in part, the silicone-containing thermoset resin, may be applied in dry form to a wet thermoset-resin saturated substrate. In this embodiment, the silicone particles may be evenly distributed on top of the thermoset resin saturated substrate before drying the silicone-treated substrate in an oven. Alternatively, the silicone particles may be mixed with the thermoset resin, and the resulting silicone-containing thermoset resin may be coated onto the substrate to form a wet silicone-containing thermoset resin substrate, to which the slurry may be subsequently added. It is noted that the slurry discussed above may or may not be added to a substrate to which the silicone-containing thermoset resin has been applied, In a preferred embodiment, the substrate comprises paper having a continuous web of alpha cellulose, and having a basis weight of about 10 grams per square meter (“gsm”) to about 100 gsm.

The way in which the slurry is applied to the impregnated substrate may be varied. However, in an exemplary embodiment, the method comprises spraying the slurry at the substrate under pressure, as is customarily done in a fountain ARP system. For example, utilizing the principles of the fountain ARP system, a fountain may continuously spray the slurry on to the substrate. The coated substrate may then pass through a set of smooth rotating rolls which meter away the excess slurry.

Additionally or alternatively, use of a receptacle containing the slurry, and a rotating doctor-roll placed within or above the receptacle, as is customarily done in a Gravure system, may be employed. In the Gravure system, the substrate may pass through or within the receptacle and the slurry may be distributed evenly onto the substrate as the substrate is continuously fed through the doctor-roll. More particularly, the Gravure system utilizes a rotating roll which is engraved with open cells. The open cells hold the slurry which is continuously pumped into the cells. As the substrate passes under the rotating roll, the slurry is deposited onto the substrate.

Furthermore, a combination of the two systems, namely a device utilizing a fountain, rolls, and open cells is contemplated by this disclosure. The device may also comprise a scraper plate intended to give an even feeding of the slurry along the surface of, e.g., the Gravure-roll.

Other devices may also be used for application of the slurry to the wet substrate. For instance, one or more of dry powder coating, electrostatic coating, reverse roll technology, and the like, may be employed to apply the slurry to the wet substrate. It is also possible to charge the laminate enhancing agents by means of friction and then apply the slurry to the thermoset resin layer on the wet substrate. This charge can be brought about, for example, by rubbing the particles against a Teflon surface.

Once the composite comprising the silicone-containing thermoset resin-impregnated substrate and the slurry is formed, the composite is dried and cured. After cure, the concentration of the laminate enhancing agents on the coating comprises about 0.1 gsm to about 50 gsm. After dry and cure, the cured composite may be cut for use as an overlay in the formation of a laminate.

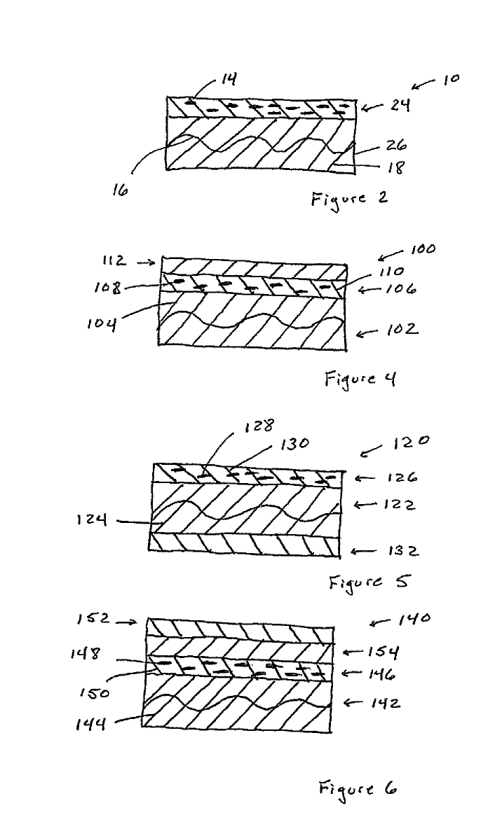

Referring to FIG. 2, an overlay 10 may be formed from the process disclosed above with reference to FIG. 1. Here, overlay 10 comprises a slurry coating 24 and a substrate 26. Slurry coating 24 comprises a silicone-containing thermoset resin 12 and a mix of laminate enhancing agents 14. Additionally, substrate 26 comprises an alpha-cellulose web 16 and a thermoset resin 18, wherein thermoset resin 18 and thermoset resin 12 may be identical to or different from each other.

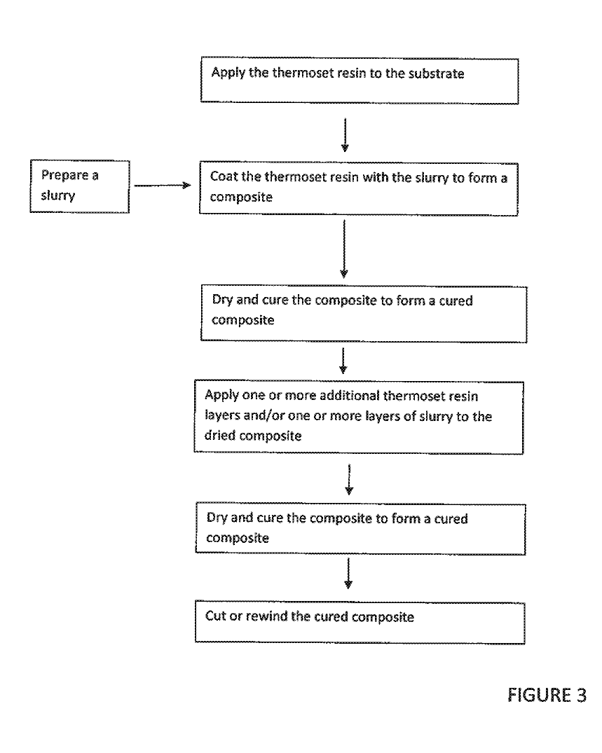

FIG. 3 depicts an exemplary method for forming another exemplary overlay, wherein the method of FIG. 3 is identical to that disclosed in FIG. 1, but also comprises applying one or more additional silicone-containing thermoset resin layers and/or layers of slurry to the cured composite formed according to the process set forth in FIG. 1, wherein the additional silicone-containing thermoset resin layers and/or additional slurry layers may comprise the same or different thermoset resin(s) and/or layers of slurry used to form the uncured composite. That is, after the initial composite is dried and cured, and prior to cutting, one or more additional silicone-containing thermoset resin layers and/or slurry coat(s) may be added to the cured composite. The resulting composite, now comprising the additional thermoset resin layer(s) and/or slurry coat(s), may then again be dried and cured. The resulting final cured composite may then be cut or rewound for use as an overlay in the formation of a laminate.

It is contemplated that one or more of the additional silicone-containing thermoset resin layers may be applied to any one of the slurry coating, the substrate, or to a prior placed additional thermoset resin layer and/or additional layer of slurry. Additionally, in a particularly preferred embodiment, the additional layer of slurry is preferably applied to at least one of the initial layer of slurry, i.e., the layer of slurry that is coated directly onto the substrate, another additional layer of slurry, or to an additional thermoset resin layer, wherein such positioning of the additional layer of slurry is preferably indirectly positioned on the same side of the substrate as the initial layer of slurry, i.e., the additional layer of slurry preferably will not be sandwiched between the substrate and the core when the laminate is formed.

An exemplary method of forming the overlay comprising one or more additional silicone-containing thermoset resin layers comprises impregnating a substrate with about a 5 gsm to about a 250 gsm coating of a thermoset resin, and then coating the silicone-containing thermoset resin-impregnated substrate with about a 5 gsm to about a 250 gsm coating of the slurry. The thermoset resin layer and the slurry may be dried and cured with sufficient time and temperature (about 80 degrees Celsius to about 200 degrees Celsius) to achieve a volatile content of about 2 percent to about 10 percent (as measured at 165 degrees Celsius for 5 minutes). This drying process forms a cured composite. After or partway through the drying process, one or more additional silicone-containing thermoset resin layers and/or slurry layers may be added to the composite, wherein such additional thermoset resin layers and/or slurry layers may be directly added to the dried slurry layer, directly to the substrate, and/or directly to an adjacently placed additional resin layer. After the additional layers are added, the composite may be dried with sufficient time and temperature (about 80 degrees Celsius to about 200 degrees Celsius) to achieve a volatile content of about 2 percent to about 10 percent (as measured at 165 degree Celsius for about 5 minutes).

Exemplary overlays formed from the process set forth in FIG. 3 are depicted in FIGS. 4-7. Referring to FIG. 4, an overlay 100 comprises a substrate 102 impregnated with a silicone-containing thermoset resin 104, and having a slurry coating 106 comprising a mix of laminate enhancing agents 108 and a thermoset resin 110 disposed on a top of substrate 102. In this embodiment, overlay 100 further comprises a thermoset resin layer 112 disposed on top of slurry coating 106.

Referring to FIG. 5, an overlay 120 comprises a substrate 122 impregnated with a silicone-containing thermoset resin 124, and having a slurry coating 126 comprising a mix of laminate enhancing agents 128 and a thermoset resin 130 disposed on top of substrate 122. In this embodiment, overlay 120 further comprises a thermoset resin layer 132 disposed on a bottom side of substrate 122.

Referring to FIG. 6, an overlay 140 comprises a substrate 142 impregnated with a silicone-containing thermoset resin 144, and having a slurry coating 146 comprising a mix of laminate enhancing agents 148 and a thermoset resin 150 disposed on top of substrate 142. In this embodiment, overlay 140 further comprises two additional thermoset resin layers 152 and 154 stacked on top of slurry coating 146.

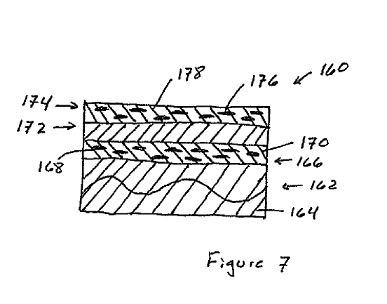

Referring to FIG. 7, an overlay 160 comprises a substrate 162 impregnated with a thermoset resin 164, and having a slurry coating 166 comprising a mix of laminate enhancing agents coated with silicone 168 and a thermoset resin 170 disposed on top of substrate 162. In this embodiment, overlay 160 further comprises a resin layer 172 and a slurry coating 174, wherein slurry coating 174 comprises laminate enhancing agents 176 and a thermoset resin 178, wherein laminate enhancing agents 176 and thermoset resin 178 may be identical to or different from respective laminate enhancing agents 168 and thermoset resin 170.

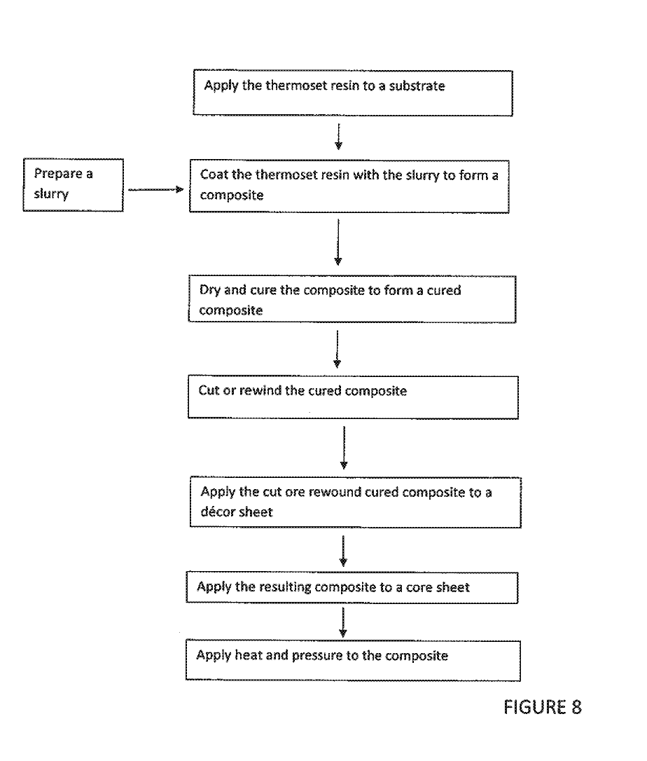

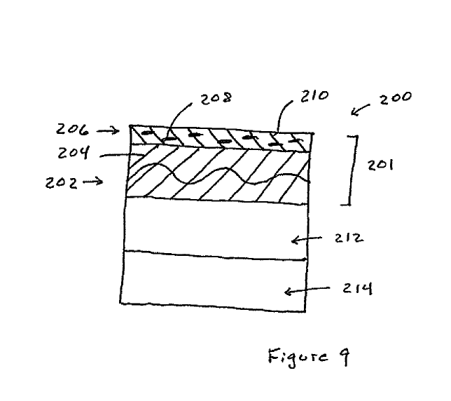

In addition to the production of a novel overlay, the invention also relates to a process for the production of a decorative thermosetting laminate having an abrasion-resistant overlay, wherein the overlay is formed according to the above-described methods. That is, referring to FIG. 8, the overlay formed from either of the methods described above may be pressed under heat of about 200 degrees Fahrenheit to about 500 degrees Fahrenheit, and a pressure of about 100 pounds per square inch to about 1,800 pounds per square inch, with core and décor sheets to create an exemplary decorative laminate 200 as depicted in FIG. 9. Referring to FIG. 9, exemplary laminate 200 comprises an overlay 201 comprising a substrate 202 impregnated with a silicone-containing thermoset resin 204 and having a slurry coating 206 disposed on top thereof. Slurry coating 206 comprises a mix of silicone coated laminate enhancing agents 208 and a silicone-containing thermoset resin 210. In addition to overlay 201, laminate 200 further comprises a décor layer 212, and a core 214. Preferably, laminate 200 is pressed with slurry coating 206 side up to create a protective layer on the surface of laminate 200 which provides wear resistance and superior clarity, and scuff-, mar-, scratch- and impact-resistance.

In addition to forming a laminate comprising an overlay formed via the application of a slurry comprising a silicone thermoplastic resin and a mix of platelet, cylindrical, fiber-like shaped laminate enhancing agents formed from one or more of glass, ceramic, and plastic, the present invention further encompasses the formation of a laminate comprising a décor layer, wherein a décor sheet, which ultimately forms the décor layer, may be treated with the silicone coated laminate enhancing agents at the printing stage (i.e., the stage at which a design component is applied to the décor sheet), and/or at the treating stage (i.e., the stage at which the décor sheet is impregnated with a thermoplastic resin). When applied at the printing stage, the silicone coated laminate enhancing agents may be applied to the décor sheet in a slurry as described above with reference to the application of a slurry to a substrate forming an overlay and/or in a substantially dry form, i.e., the laminate enhancing agents may be applied directly onto the décor sheet without the use of a slurry; rather, the laminate enhancing agents may include a substantially dry mix of laminate enhancing agents. When applied at the treating stage, the laminate enhancing agents are preferably applied in the slurry.

The décor sheet may include a décor sheet as is typically used in the formation of high pressure laminates and/or low pressure laminates, and may include, for example and without limitation, monochromatic or patterned sheets of paper. After the silicone coated laminate enhancing agents are applied to the décor sheet, either at the printing stage and/or at the treating stage, the décor sheet may be directly laminated to a conventionally used core, such as, for example, paper, particleboard, fiberboard, and the like, wherein the laminate enhancing agents impart the resulting laminate with improved clarity, abrasion resistance, scuff resistance, mar resistance, and impact resistance as compared to prior art laminates. A laminate formed from such a décor layer, may or may not further comprise an overlay, wherein in a preferred embodiment, the laminate does not comprise an overlay, thereby providing improved clarity to the laminate.

As stated above, when the laminate enhancing agents are applied at the printing stage, the décor sheet may be treated with a mix of silicone coated laminate enhancing agents and/or with the slurry, wherein the slurry may be identical to or substantially the same as the slurry discussed above in relation to the overlay. The exemplary processes used to apply the slurry and/or the mix of laminate enhancing agents to the overlay may be identical or substantially identical to the processes used to apply the slurry to the overlay.

When the silicone coated laminate enhancing agents are applied to the décor sheet at the treating stage, the process(es) discussed above in relation to the formation of an overlay, applies equally to the formation of the décor layer. That is, the process for forming the décor layer may comprise impregnating a décor sheet with a thermoset resin composition, and then coating the impregnated décor sheet with the slurry as substantially disclosed above in reference to the overlay. The resulting décor layer may then be cured and dried. The process may further comprise applying at least one or more additional thermoset resin layers to the cured décor layer.

The silicone based thermoset resin composition used to impregnate the décor sheet may comprise those thermoplastic resins and/or additives which were discussed above in relation to the overlay. Additionally, and as stated above, the slurry may be identical to, or substantially similar to that disclosed above in relation to the formation of the overlay, as it imparts essentially the same properties onto the décor layer for essentially the same reasons as disclosed above.

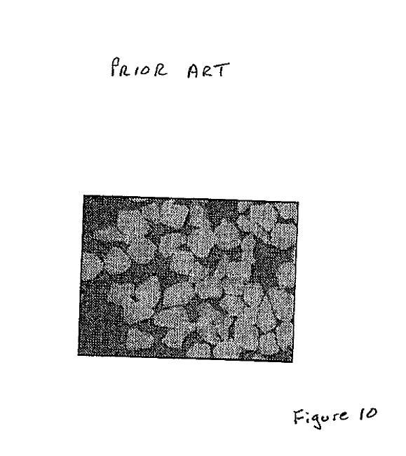

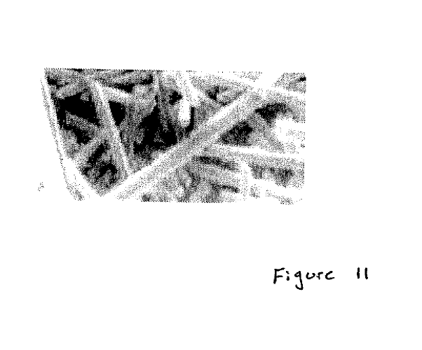

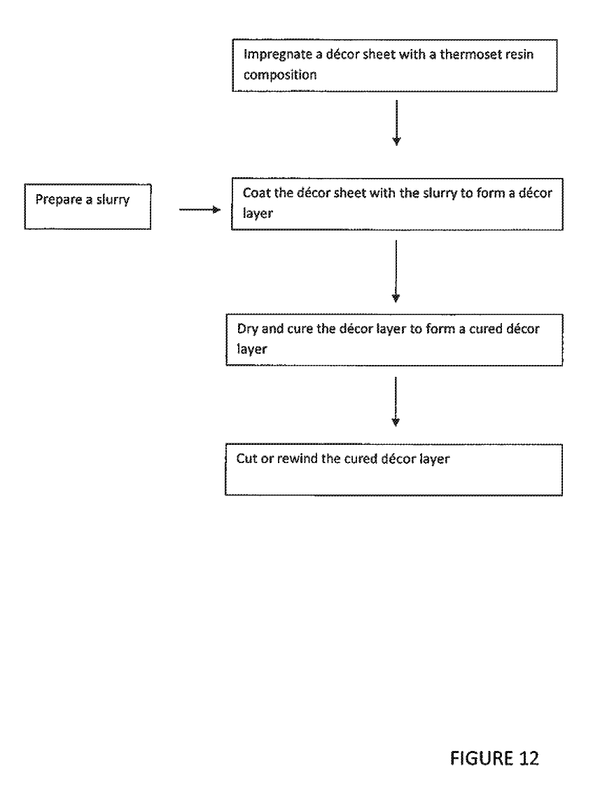

Exemplary processes used to form décor layers are discussed with reference to FIGS. 12-16 and 18-22. Referring to FIG. 12, an exemplary process for forming the décor layer at the treating stage comprises preparing a slurry having a laminate enhancing agent concentration of about 1 percent to about 50 percent, based on the total concentration of the slurry, wherein at least about 5 percent of the laminate enhancing agents have a platelet, cylindrical, fiber-like configuration, wherein the percentage is based on the total number of laminate enhancing agents contained in the slurry. The process further comprises impregnating a décor sheet with a silicone-containing thermoset resin composition, such that the décor sheet comprises a coating having about 5 gsm to about 250 gsm of the silicone-containing thermoset resin composition. The slurry may be then applied to the impregnated décor sheet while the impregnated décor sheet is still wet from the impregnation of the thermoset resin composition such that the décor sheet comprises a coating of about 5 gsm to about 250 gsm of the slurry. In a preferred embodiment, the décor sheet comprises a decorative paper having a basis weight of about 10 gsm to about 100 gsm.

The way in which the slurry may be applied to the impregnated décor sheet may be varied. However, in an exemplary embodiment, the method may include any one or more of the methods described above with relation to the method of applying the slurry to the overlay. An exemplary method of applying the slurry to a décor sheet is depicted in FIG. 45, and may apply equally to applying the slurry to an overlay, wherein the only substitution would be the overlay for the décor sheet. Referring to FIG. 45, a device 500 comprises a container 502 which holds a slurry 600, wherein, as discussed above, slurry 600 comprises a mix of laminate enhancing agents and a thermoset resin. Device 500 further comprises a rotating roll 504 which continuously feeds a décor sheet 700. Device 500 further comprises a scraper 508 which is positioned between container 502 and wheel 504. In application, as slurry 600 is poured out of container 502, it drops onto scraper 508 where it then drops onto wheel 504. As wheel 504 is rotated, slurry 600 drops from wheel 504 and onto décor sheet 700 such that slurry 600 is evenly distributed onto décor sheet 700.

Once the décor layer, comprising the silicone-containing thermoset resin-impregnated décor sheet coated with the slurry, is formed, the resulting décor layer may be dried and cured. After cure, the concentration of the silicone coated laminate enhancing agents on the décor layer may comprise about 0.1 gsm to about 50 gsm. After dry and cure, the cured décor layer may be cut for use as a surface layer in the formation of a laminate.

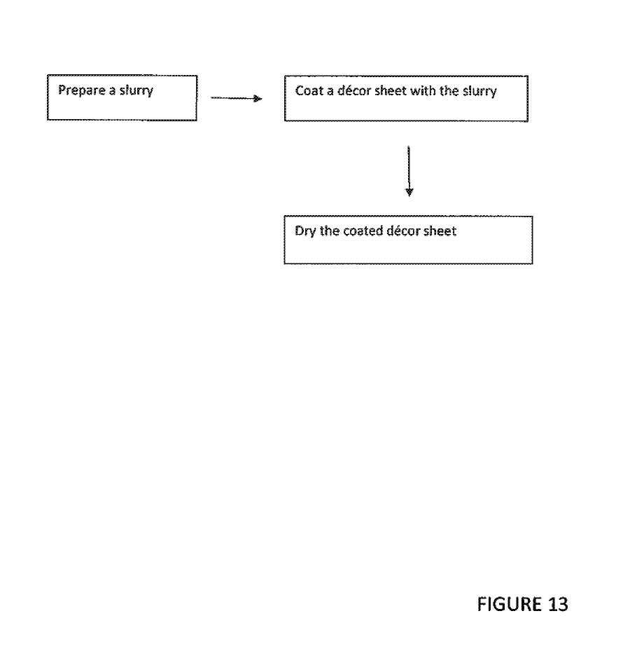

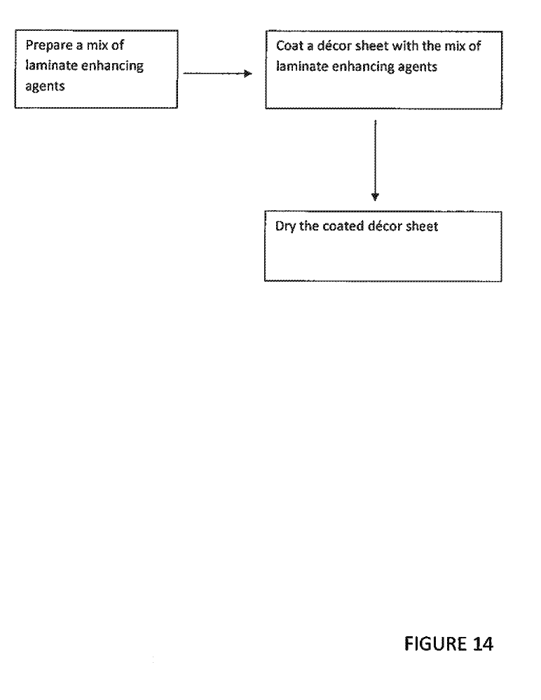

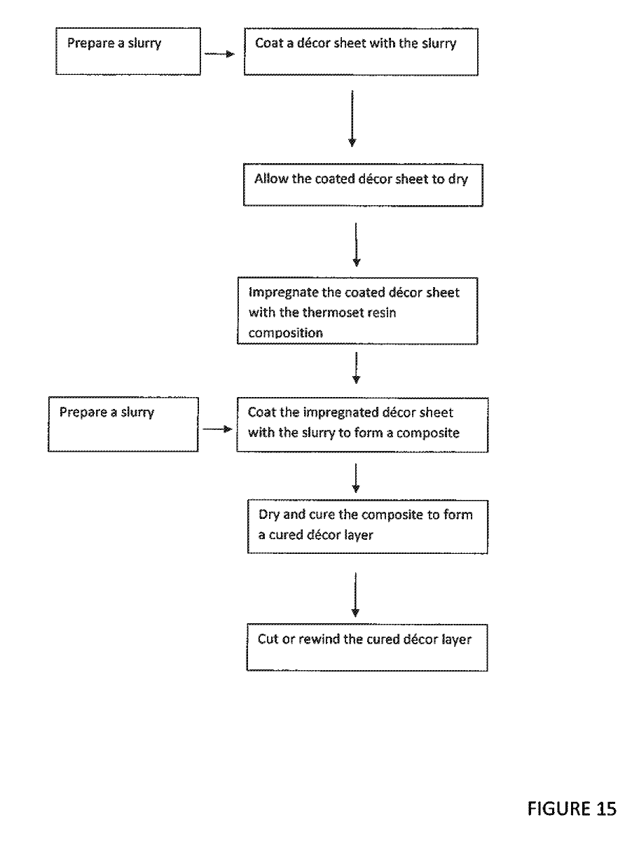

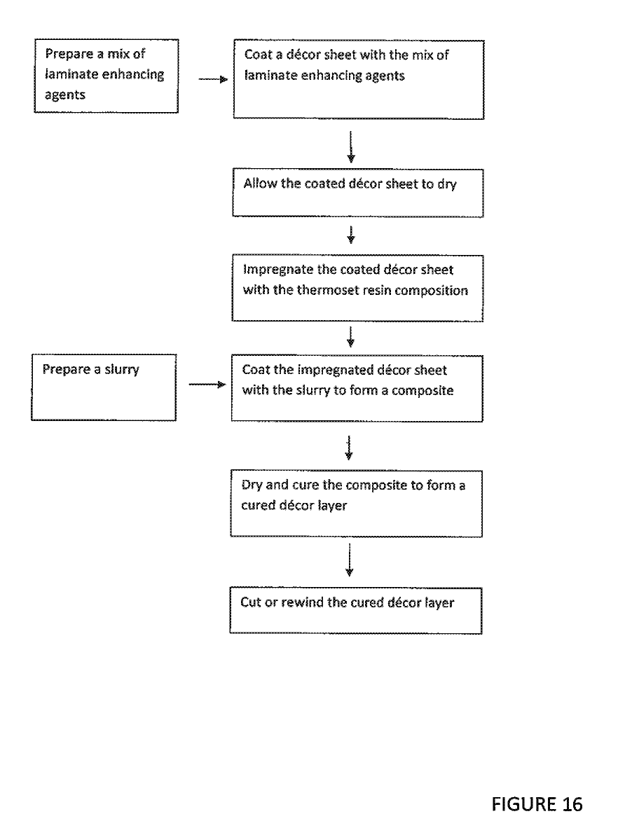

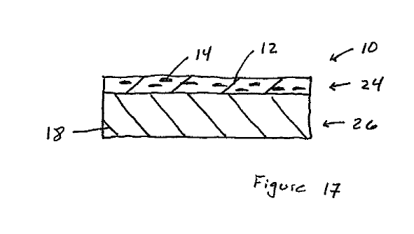

FIGS. 13-16 further depict other exemplary processes for forming a décor layer treated with the silicone coated laminate enhancing agents disclosed herein. FIG. 13 depicts the formation of a décor sheet coated with the slurry at the printing stage of the décor sheet. FIG. 14 depicts the formation of a décor sheet coated with a mix of silicone coated laminate enhancing agents at the printing stage of the décor sheet. FIG. 15 depicts the formation of a décor layer comprising coating a décor sheet at both the printing stage and at the treating stage, wherein the décor sheet is treated with a slurry at both stages. FIG. 16 depicts the formation of a décor layer comprising coating a décor sheet at both the printing stage and at the treating stage, wherein the décor sheet is treated with a mix of silicone coated laminate enhancing agents at the printing stage and with a mix of silicone coated laminate enhancing agents at the treating stage.

Referring to FIG. 17, a décor layer 10 may be formed from any one or more of the processes disclosed in FIGS. 12-16. Referring to FIG. 17, décor layer 10 comprises a slurry coating 24 and a décor sheet 26. Slurry coating 24 comprises a thermoset resin composition 12 and a mix of laminate enhancing agents 14. Additionally, décor sheet 26 is impregnated with a thermoset resin composition 18, wherein thermoset resin composition 18 and thermoset resin composition 12 may be identical to or different from each other.

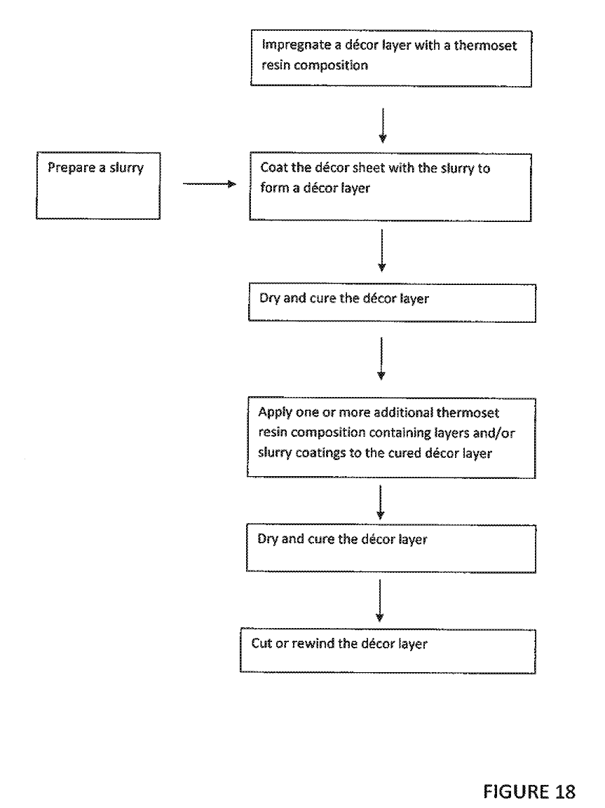

FIG. 18 depicts an exemplary method for forming another exemplary décor layer at the treating stage, wherein the method presented in FIG. 18 may be essentially identical to that disclosed in FIG. 12, but also comprises applying one or more additional thermoset resin composition containing layers and/or layers of slurry to the cured décor layer formed according to the process set forth in FIG. 12, wherein the additional thermoset resin composition containing layers and/or additional slurry layers may comprise the same or different thermoset resin composition(s) and/or layers of slurry used to form the uncured décor layer. That is, after the initial décor layer is dried and cured, and prior to cutting, one or more additional thermoset resin composition containing layers and/or slurry coat(s) may be added to the cured décor layer. The resulting décor composite, now comprising the additional thermoset resin composition containing layer(s) and/or slurry coat(s), may then again be dried and cured. The resulting final cured décor composite may then be cut or rewound for use as a surface layer in the formation of a laminate.

It is contemplated that one or more of the additional thermoset resin composition containing layers may be applied to any one of the slurry coating, the décor layer, or to a prior placed additional thermoset resin composition containing layer and/or additional layer of slurry. Additionally, in a particularly preferred embodiment, the additional layer of slurry is preferably applied to at least one of the initial layer of slurry, i.e., the layer of slurry that is coated directly onto the impregnated décor sheet, another additional layer of slurry, or to an additional thermoset resin composition containing layer, wherein such positioning of the additional layer of slurry is preferably indirectly positioned on the same side of the décor layer as the initial layer of slurry, i.e., the additional layer of slurry preferably will not be sandwiched between the décor layer and the core when the laminate is formed.

An exemplary method of forming the décor layer comprising one or more additional thermoset resin layers comprises impregnating a décor sheet with about a 5 to about a 250 gsm coating of a thermoset resin composition, and then coating the impregnated décor sheet with about a 5 to about a 250 gsm coating of slurry. The coated and impregnated décor layer may be then dried and cured with sufficient time and temperature (about 80 degrees Celsius to about 200 degrees Celsius) to achieve a volatile content of about 2 percent to about 10 percent (as measured at 165 degrees Celsius for 5 minutes). This drying process forms a cured décor layer. After or partway through the drying process, one or more additional thermoset resin composition layers and/or slurry layers may be added to the décor layer, wherein such additional thermoset resin composition layers and/or slurry layers may be directly added to the dried slurry layer, directly to the décor sheet, and/or directly to an adjacently placed additional resin layer. After the additional layers are added, the décor layer may be dried with sufficient time and temperature (about 80 degrees Celsius to about 200 degrees Celsius) to achieve a volatile content of about 2 percent to about 10 percent (as measured at 165 degree Celsius for 5 minutes).

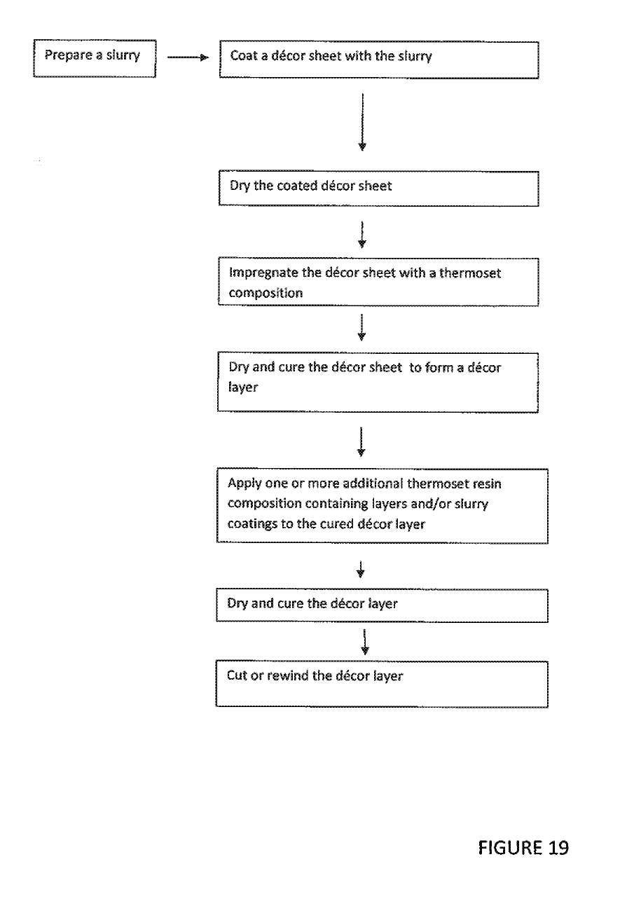

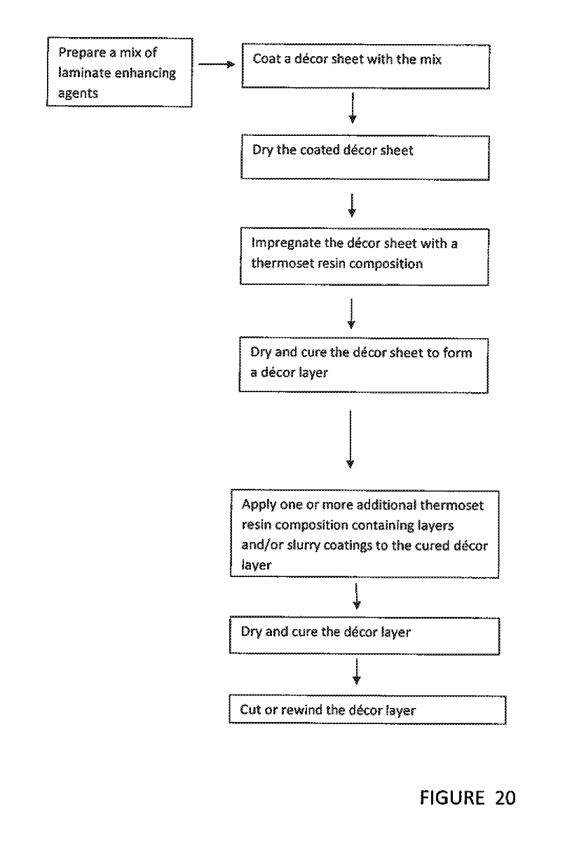

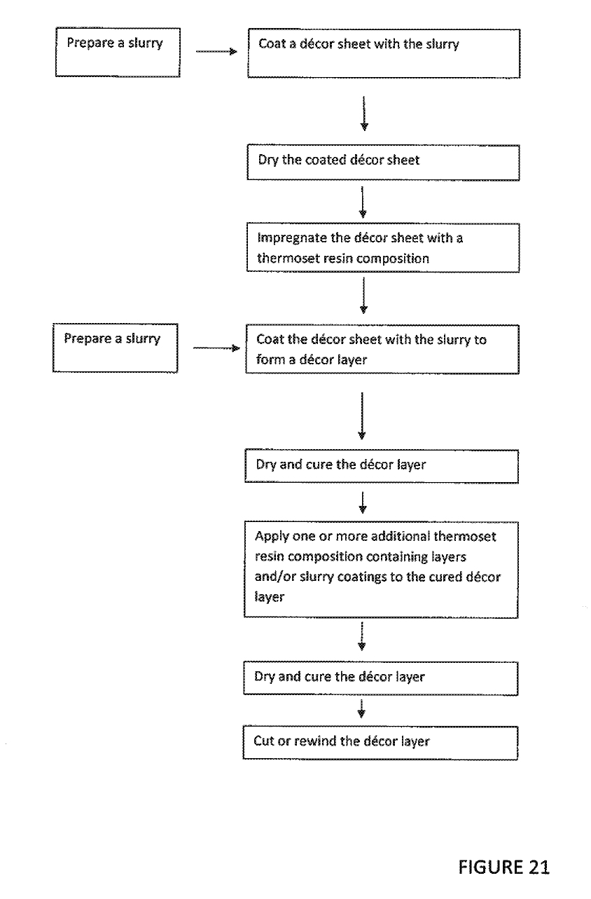

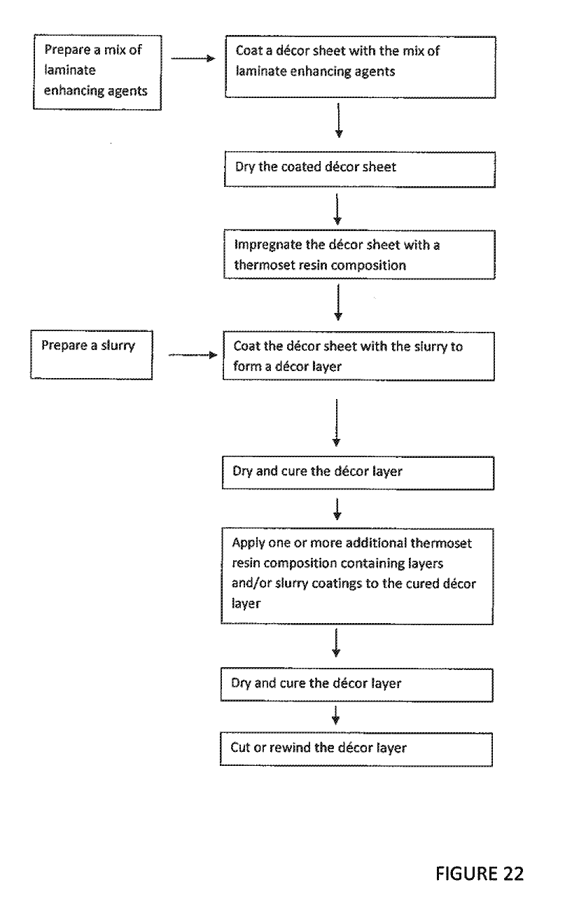

FIGS. 19-22 depict other exemplary processes used to form a décor sheet, wherein the processes may take advantage of the same principles used in process described above in FIG. 18 to generate a décor layer having the same general characteristics and properties as a décor layer formed according to the process depicted in FIG. 18, More specifically, FIG. 19 depicts a décor layer formed by coating a décor sheet with a slurry at the printing stage. FIG. 20 depicts a décor layer formed by coating a décor sheet with a mix of laminate enhancing agents at the printing stage. FIG. 21 depicts a décor layer formed by coating a décor sheet with a slurry at both the printing stage and at the treating stage. And FIG. 22 depicts a décor layer formed by coating a décor sheet with a mix of laminate enhancing agents at the printing stage and with a slurry at the treating stage.

Exemplary décor sheets formed from one or more of the processes set forth in FIG. 18-22 are depicted in FIGS. 23-26. Referring to FIG. 23, a décor layer 100 comprises a décor sheet 102 impregnated with a thermoset resin composition 104, and coated with a slurry coating 106 comprising a mix of laminate enhancing agents 108 and a thermoset resin composition 110 disposed on a top of décor sheet 102. In this embodiment, décor layer 100 further comprises a thermoset resin composition layer 112 disposed on top of slurry coating 106.

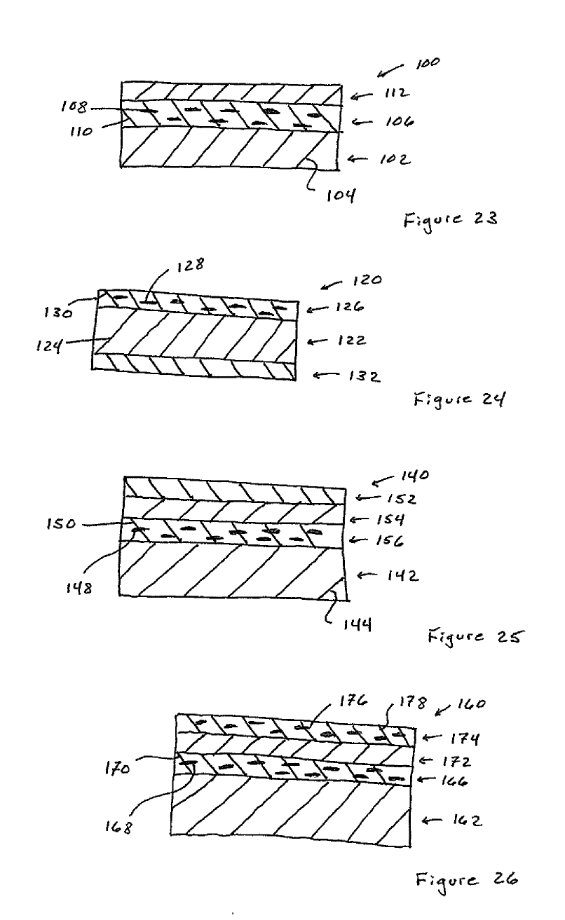

Referring to FIG. 24, a décor layer 120 comprises a décor sheet 122 impregnated with a thermoset resin composition 124, and coated with a slurry coating 126 comprising a mix of laminate enhancing agents 128 and a thermoset resin composition 130 disposed on top of décor sheet 122. In this embodiment, décor layer 120 further comprises a thermoset resin composition layer 132 disposed on a bottom side of décor sheet 122.

Referring to FIG. 25, a décor layer 140 comprises a décor sheet 142 impregnated with a thermoset resin composition 144, and coated with a slurry coating 156 comprising a mix of laminate enhancing agents 148 and a thermoset resin composition 150 disposed on top of décor sheet 142. In this embodiment, décor layer 140 further comprises two additional thermoset resin composition layers 152 and 154 stacked on top of slurry coating 156.

Referring to FIG. 26, a décor layer 160 comprises a décor sheet 162 impregnated with a thermoset resin composition 164, and coated with a slurry coating 166 comprising a mix of laminate enhancing agents 168 and a thermoset resin composition 170 disposed on top of décor sheet 162. In this embodiment, décor layer 160 further comprises a thermoset resin composition layer 172 and a slurry coating 174, wherein slurry coating 174 comprises a mix of laminate enhancing agents 176 and a thermoset resin composition 178, wherein mix of laminate enhancing agents 176 and thermoset resin composition 178 may be identical to or different from respective mix of laminate enhancing agents 168 and thermoset resin composition 170.

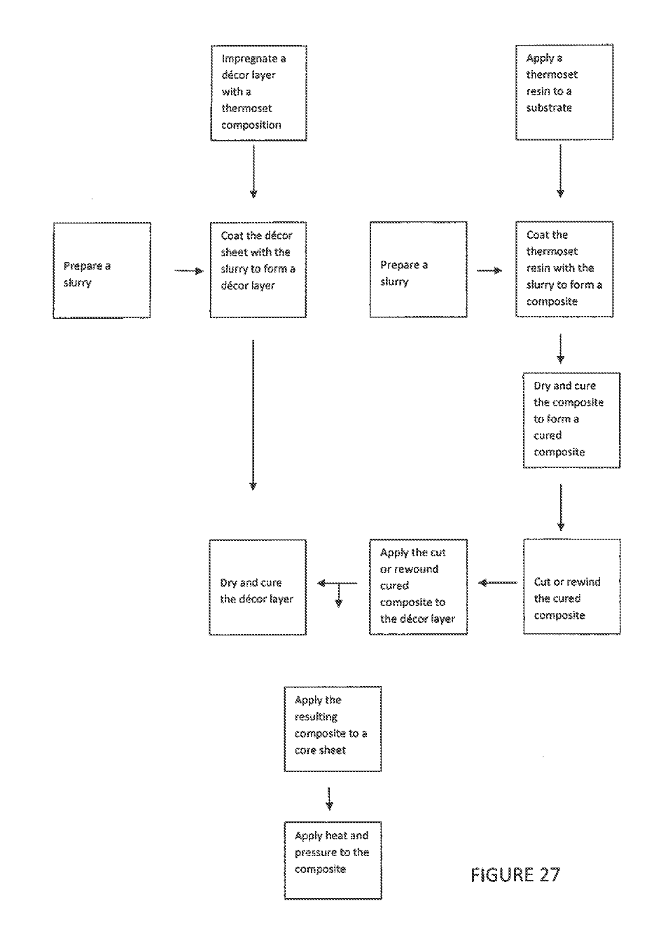

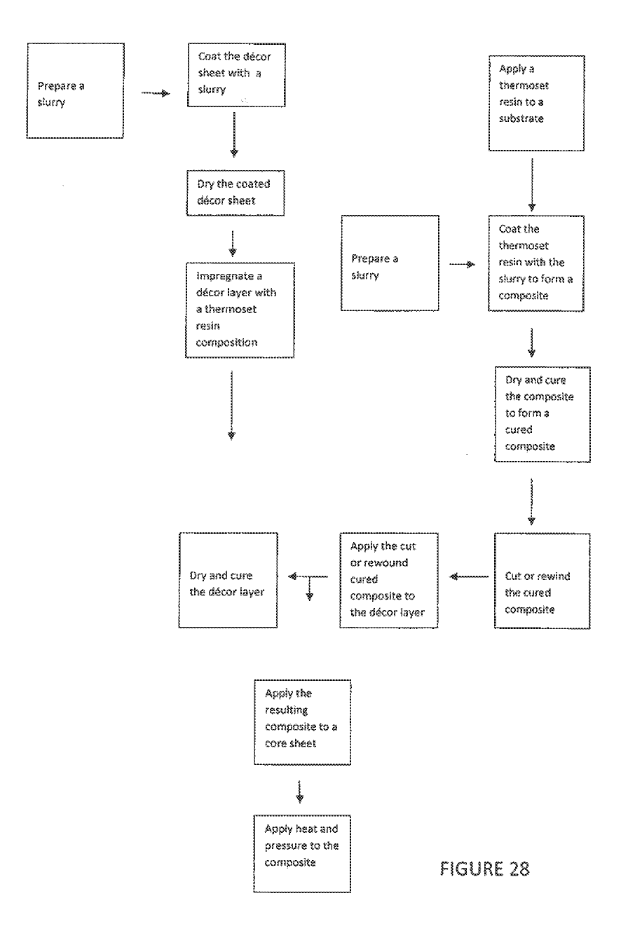

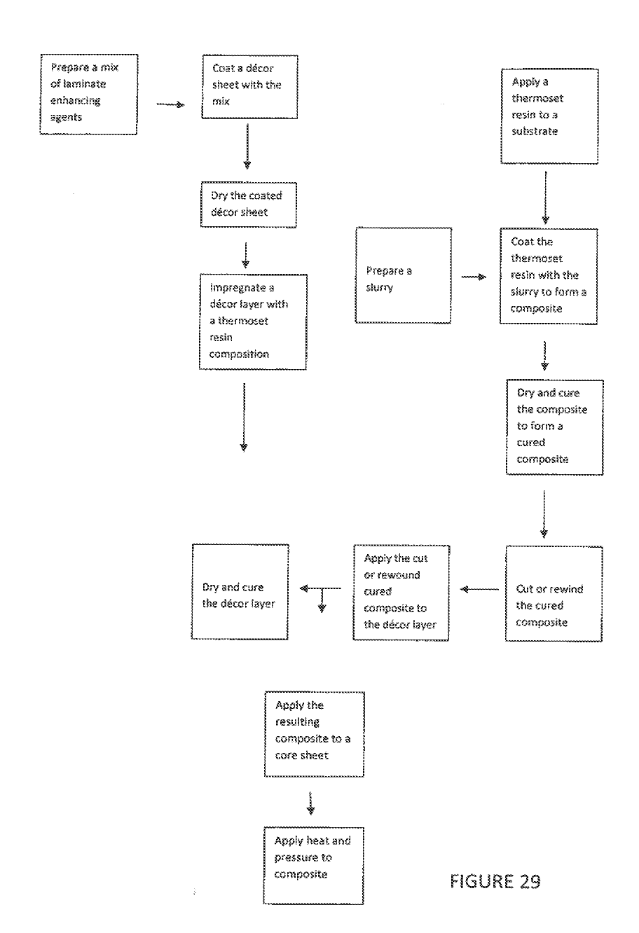

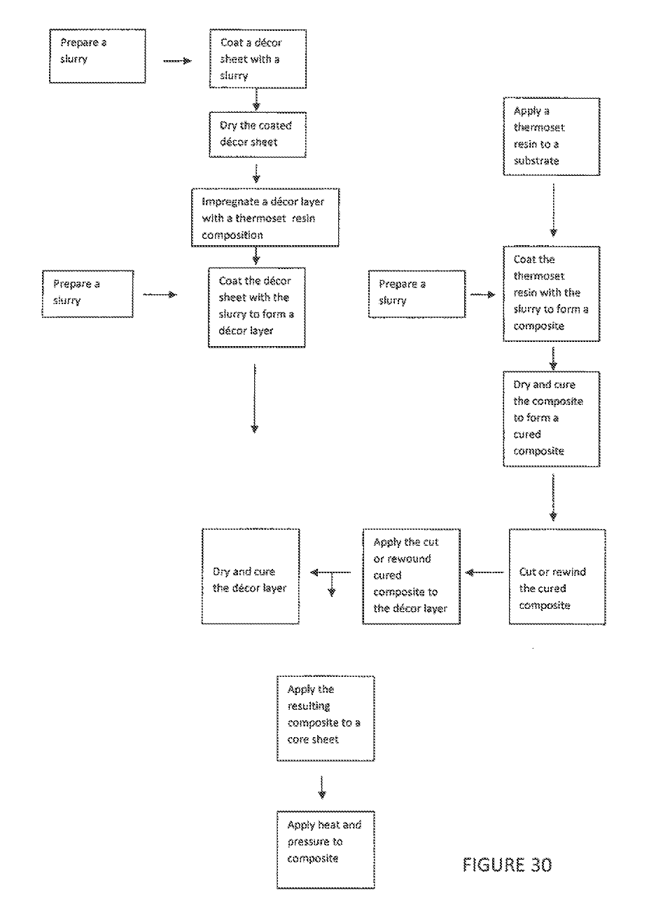

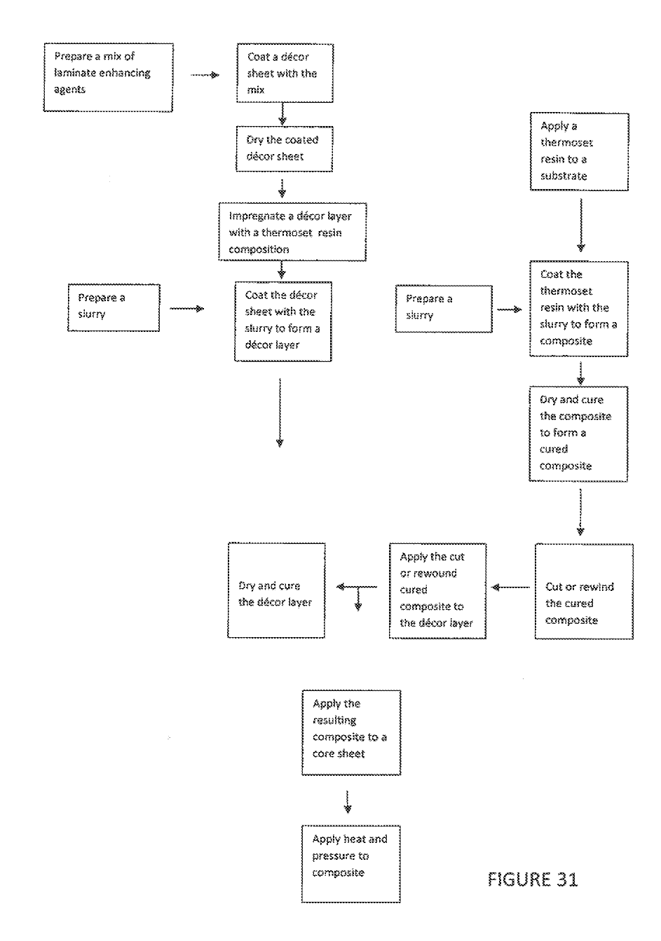

In addition to the production of a novel décor layer, the invention also relates to a process for the production of a decorative thermosetting laminate having an abrasion-resistant surface layer, wherein the surface layer is formed according to the above-described methods. FIG. 27 depicts a process for forming a laminate, wherein the laminate comprises both an overlay formed by coating a substrate with a silicone based slurry at the treating stage, and a décor layer formed by coating a décor sheet with a slurry at the treating stage. FIG. 28 depicts a process for forming a laminate, wherein the laminate comprises both an overlay formed by coating a substrate with a slurry, and a décor layer formed by coating a décor sheet with a silicone based slurry at the printing stage. FIG. 29 depicts a process for forming a laminate, wherein the laminate comprises both an overlay formed by coating a substrate with a slurry, and a décor layer formed by coating a décor sheet with a mix of laminate enhancing agents at the printing stage. FIG. 30 depicts a process for forming a laminate, wherein the laminate comprises both an overlay formed by coating a substrate with a slurry, and a décor layer formed by coating a décor sheet with a slurry at both the printing stage and the treating stage. FIG. 31 depicts a process for forming a laminate, wherein the laminate comprises both an overly formed by coating a substrate with a slurry, and a décor layer formed by coating a décor sheet with a mix of laminate enhancing agents at the printing stage and with a slurry at the treating stage.

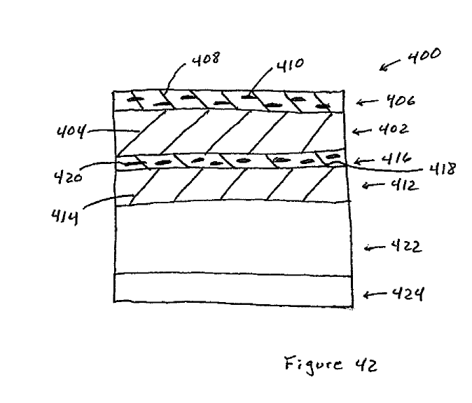

Referring to FIG. 42, an exemplary laminate 400, which may be formed from any one or more of the processes set forth above in FIGS. 27-31, comprises an overlay 402 impregnated with a thermoset resin composition 404. Overlay 402 is covered with a slurry 406 comprising a thermoset resin composition 408 and a mix of laminate enhancing agents 410. Laminate 400 further comprises a décor layer 412 impregnated with a thermoset resin composition 414 and coated with a slurry 416 comprising a thermoset resin composition 418 and a mix of laminate enhancing agents 420. Laminate 400 further comprises a core 422 and a base 424.

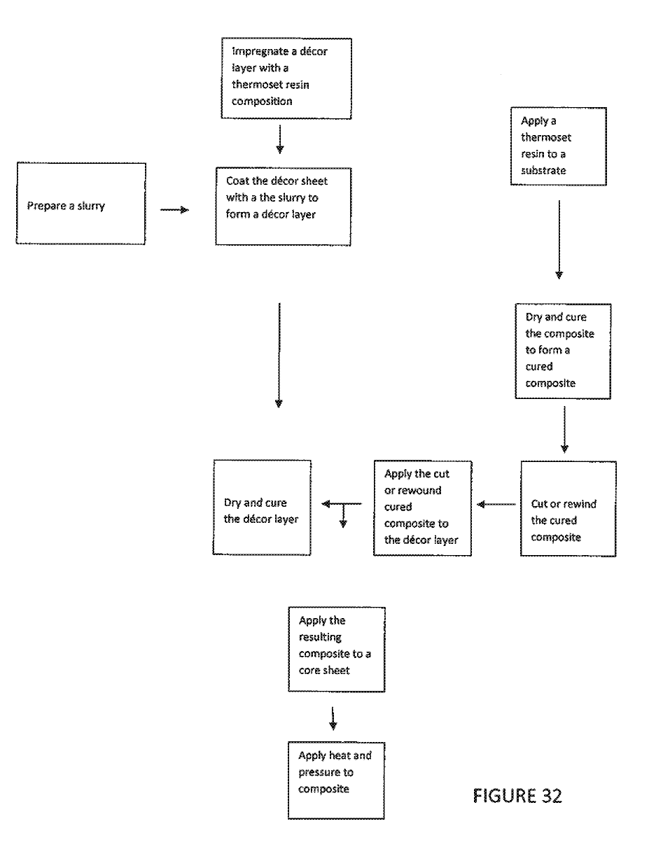

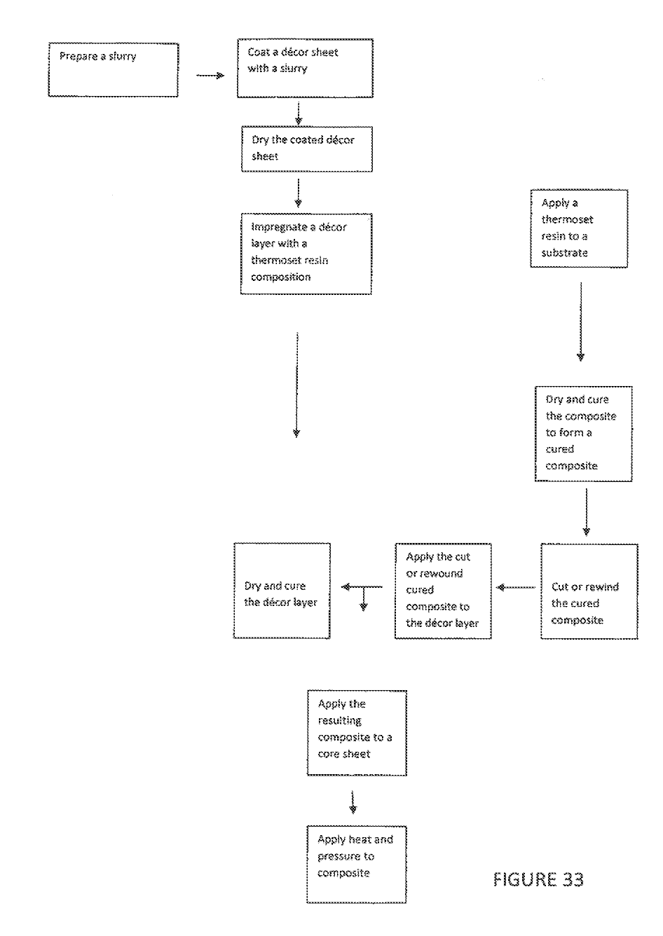

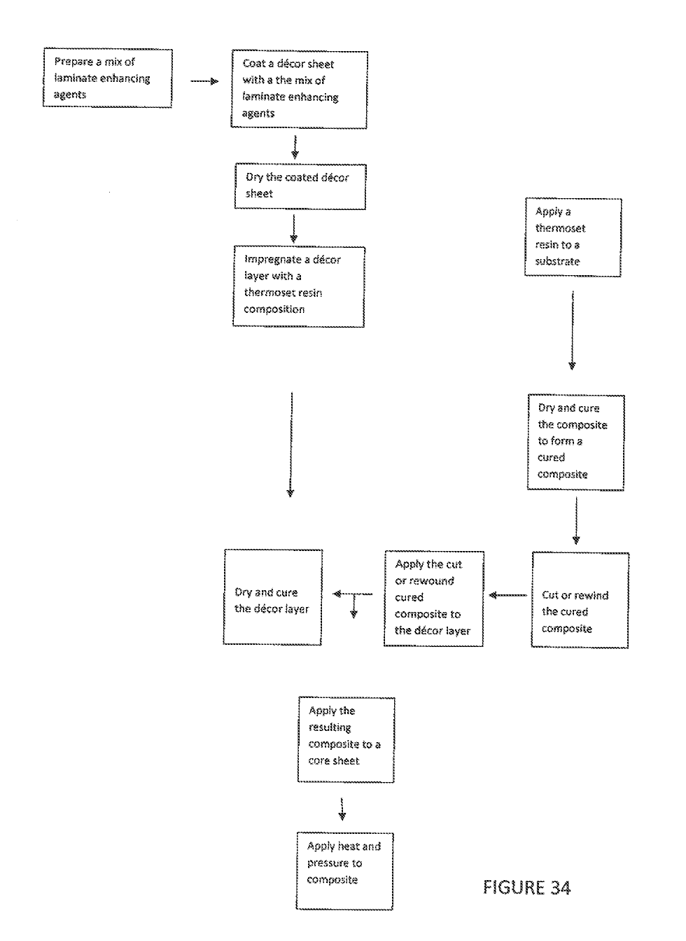

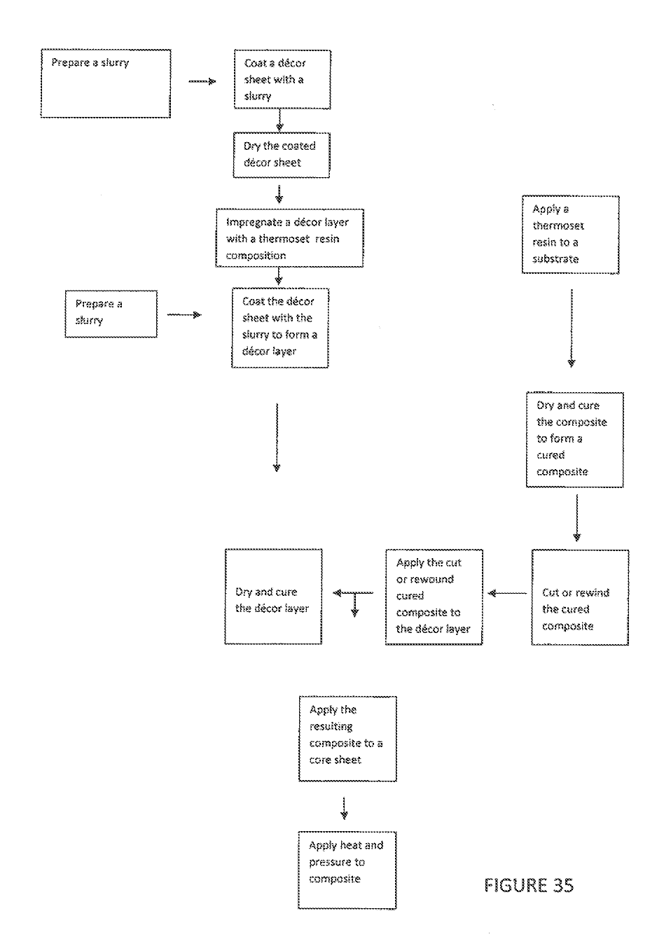

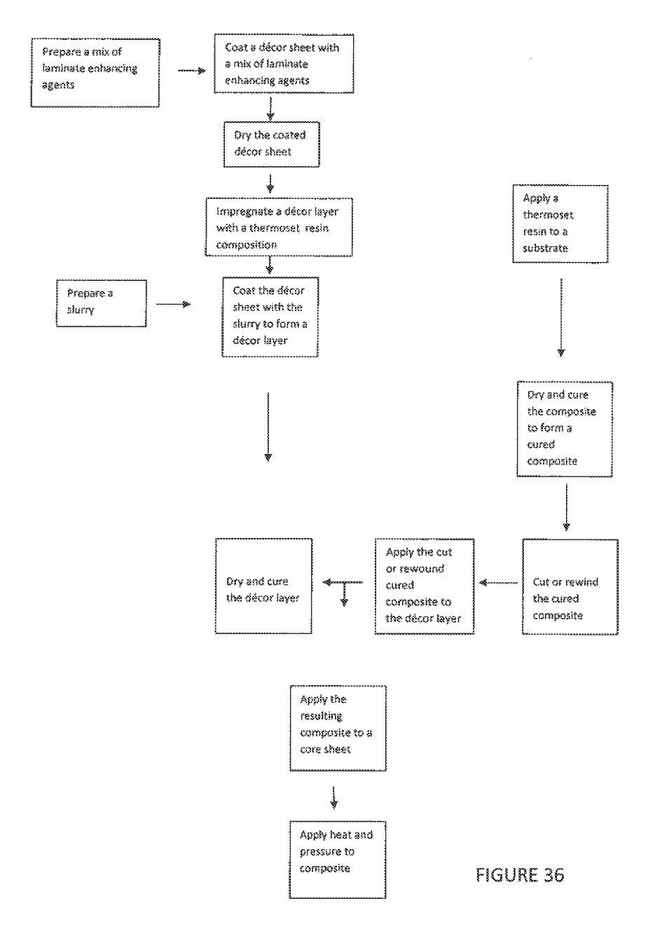

FIG. 32 depicts a process for forming a laminate, wherein the laminate comprises both an overlay and a décor layer, wherein the décor layer is coated with a silicone slurry at the treating stage. FIG. 33 depicts a laminate comprising both an overlay and a décor layer, wherein the décor layer is coated with a slurry at the printing stage. FIG. 34 depicts a process for forming a laminate, wherein the laminate comprises both an overlay and a décor layer, wherein the décor layer is coated with a mix of laminate enhancing agents at the printing stage. FIG. 35 depicts a process for forming a laminate, wherein the laminate comprises both an overlay and a décor layer, wherein the décor layer is coated with a slurry at the printing stage and is further coated with a slurry at the treating stage. FIG. 36 depicts a process for forming a laminate, wherein the laminate comprises both an overlay and a décor layer, wherein the décor layer is coated with a mix of laminate enhancing agents at the printing stage and is further coated with a slurry at the treating stage.

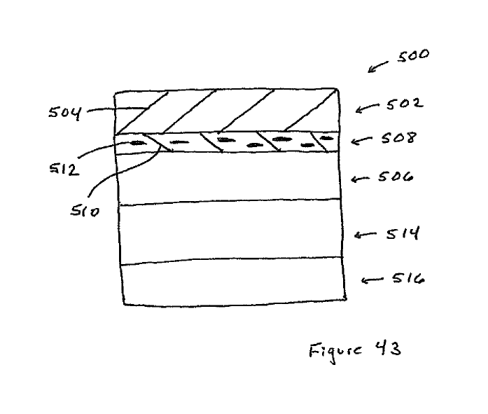

Referring to FIG. 43, exemplary laminate 500, which may be formed from any one or more of the processes set forth above in FIGS. 32-36, comprises an overlay 502 impregnated with a thermoset resin composition 504. Laminate 500 further comprises a décor layer 506. Décor layer 506 has coated thereon a slurry 508, which comprises a thermoset resin composition 510 and a mix of laminate enhancing agents 512. Laminate 500 further comprises a core 514 and a base 516.

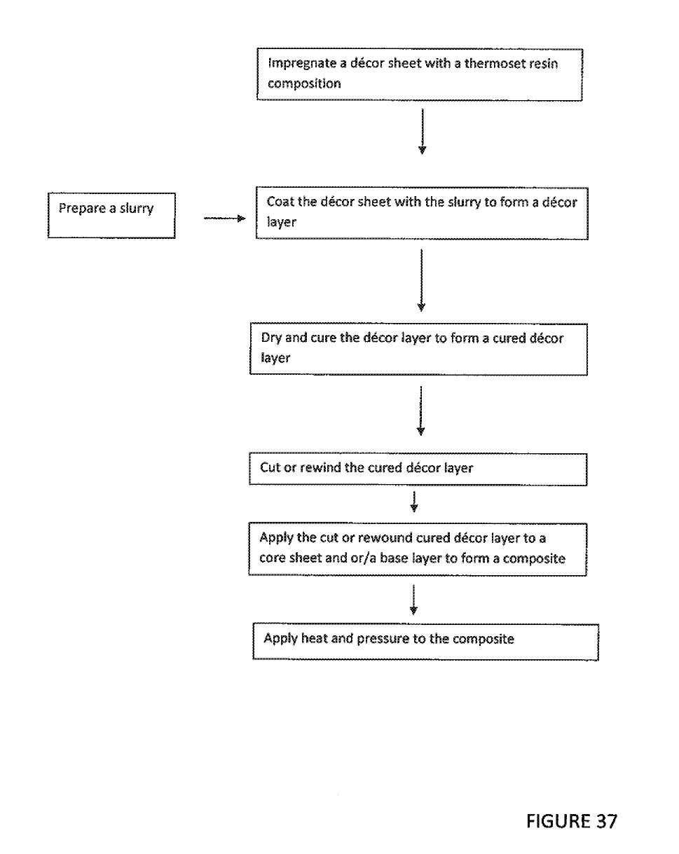

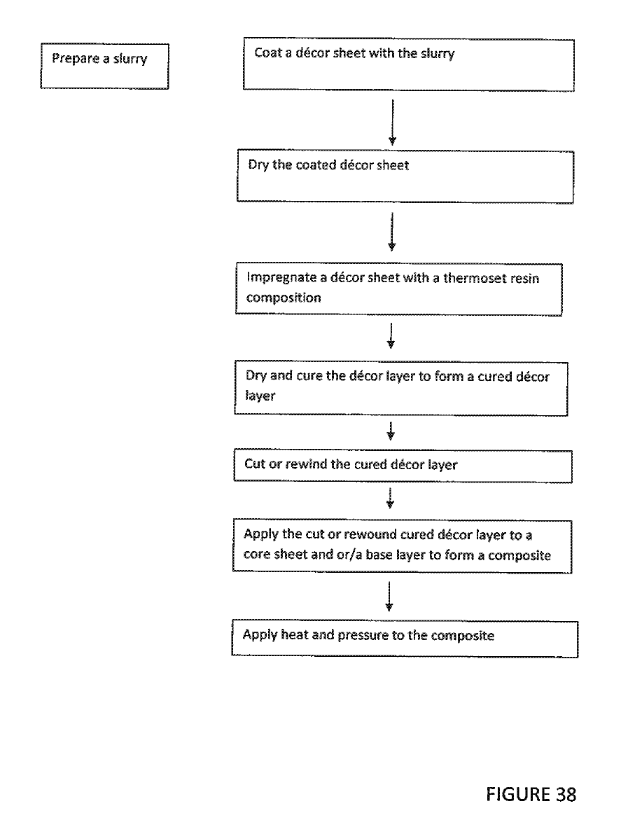

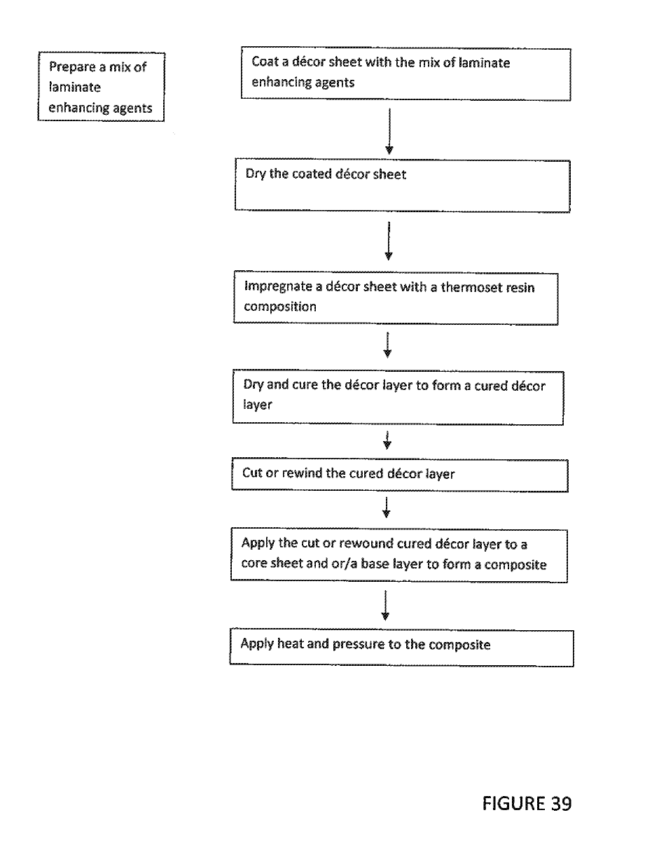

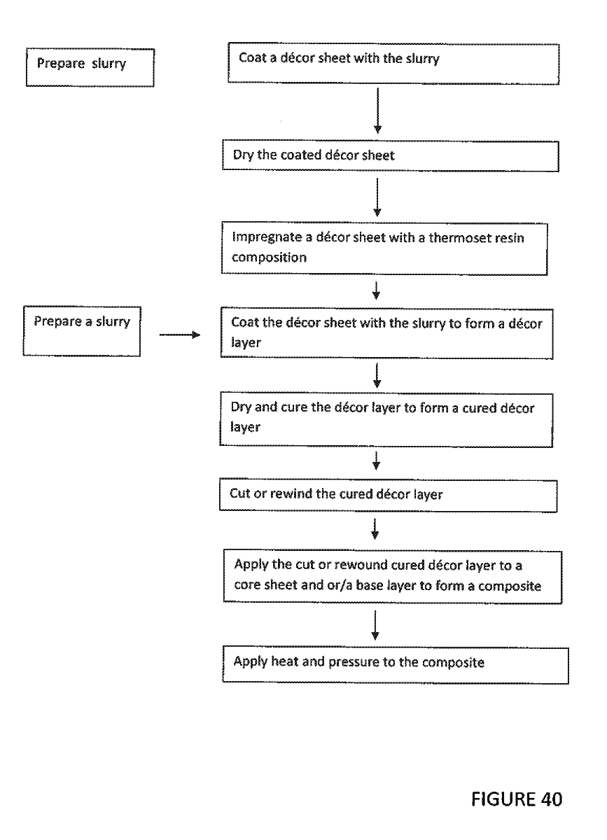

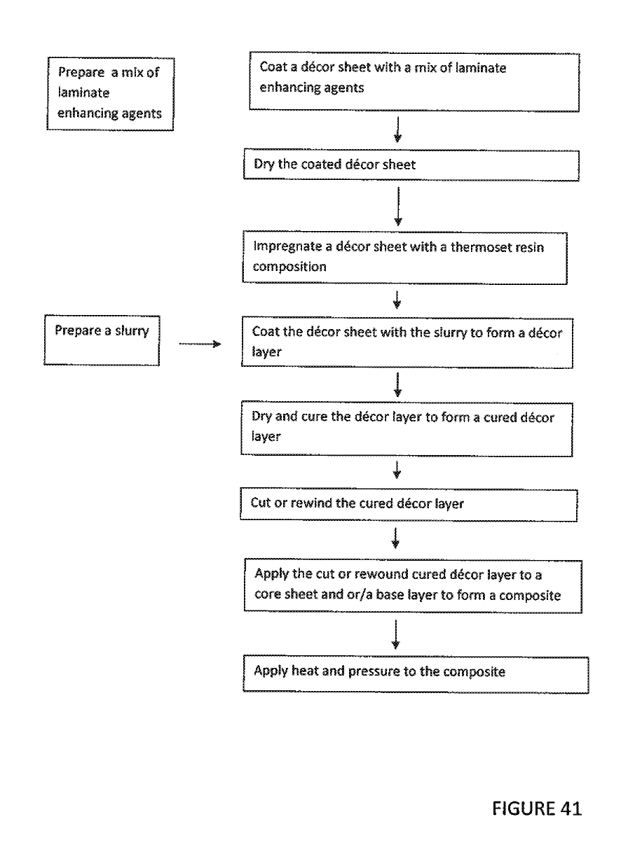

FIG. 37 depicts a process for forming a laminate, wherein the laminate comprises a décor layer formed by coating a décor sheet with a slurry at the treating stage. FIG. 38 depicts a process for forming a laminate, wherein the laminate comprises a décor layer formed by coating a décor sheet with a slurry at the printing stage. FIG. 39 depicts a process for forming a laminate, wherein the laminate comprises a décor layer formed by coating a décor sheet with a mix of laminate enhancing agents at the printing stage. FIG. 40 depicts a process for forming a laminate, wherein the laminate comprises a décor layer formed by coating a décor sheet with a slurry at both the printing stage and at the treating stage. FIG. 41 depicts a process for forming a laminate, wherein the laminate comprises a décor layer formed by coating a décor sheet with a mix of laminate enhancing agents at the printing stage and with a slurry at the treating stage.

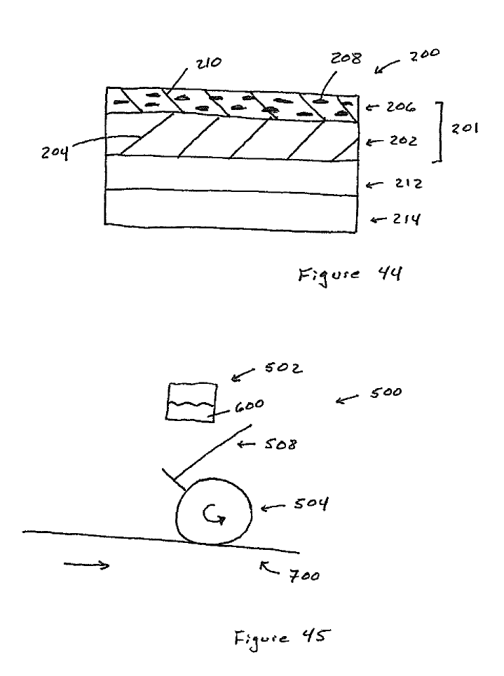

Referring to FIG. 44, exemplary laminate 200, which may be formed from any one or more of the processes set forth above in FIGS. 37-41, comprises a surface layer 201 comprising a décor layer 202 impregnated with a silicone-containing thermoset resin composition 204 and coated with a slurry coating 206 disposed on top thereof. Slurry coating 206 comprises a mix of laminate enhancing agents 208 and a thermoset resin composition 210. In addition to surface layer 201, laminate 200 further comprises a core 214 and a base layer 212. Preferably, laminate 200 is pressed with slurry coating 206 side up to create a protective layer on the surface of laminate 200 which provides wear resistance and superior clarity and scuff-, mar-, and scratch-resistance.

In any of the processes set forth in FIGS. 27-37, the surface layer formed from either of the methods described above may be pressed under heat of about 200 degrees Fahrenheit to about 500 degrees Fahrenheit, and a pressure of about 100 pounds per square inch to about 1,800 pounds per square inch, with core and base layer sheets to create an exemplary decorative laminate.

Although the present invention has been described with reference to the figures, it is to be understood that the invention is not limited thereto. Rather, the invention shall include all obvious modifications and variations to the present disclosure as would occur to one of ordinary skill in the art. Additionally, it is evident that the process according to the invention is not restricted to laminates made of sheets containing silicone based resins with a maximized cross-linked density. Also other thermosetting resins such as polyester resins are possible.

What is claimed is:

1. A method for the production of a laminate comprising forming an overlay, wherein the method of forming the overlay comprises:
impregnating a first side of a substrate with a first silicone based thermosetting resin;
coating the first side of the substrate with a layer of slurry to form a composite, wherein the slurry comprises a second silicone based thermosetting resin and a mix of laminate enhancing agents, wherein the mix of laminate enhancing agents comprises at least about 5 percent of platelet, platelet, cylindrical, fiber-like shaped laminate enhancing agents; and
curing the composite to form a cured composite.

2. The method of claim 1, wherein the mix of laminate enhancing agents further comprises laminate enhancing agents having a crystalline shape.

3. The method of claim 2, wherein the first thermosetting resin comprises a crosslinked silicone based resin.

4. The method of claim 3, wherein the second thermosetting resin comprises a crosslinked silicone based resin.

5. The method of claim 1, wherein the substrate comprises an alpha-cellulose based paper.

6. The method of claim 1, wherein the platelet, cylindrical, fiber-like shaped laminate enhancing agents comprises at least one of glass, ceramic, and plastic.

7. The method of claim 6, wherein the mix of laminate enhancing agents are coated in powder or liquid silicone and further comprise alumina, silica and titania.

8. The method of claim 1, wherein the platelet, cylindrical, fiber-like shaped laminate enhancing agents comprise an average particle diameter of 10-16 microns and length of about 120 micrometers to about 290 micrometers

9. The method of claim 1, wherein the platelet, cylindrical, fiber-like shaped laminate enhancing agents are of various lengths and are cut at various angles.

10. The method of claim 1, wherein the platelet, cylindrical, fiber-like shaped laminate enhancing agents comprise an aspect ratio of about 2:1 to about 25:1.

11. The method of claim 1, further comprising preparing the layer of slurry, wherein the layer of slurry comprises about 1 to about 50 percent of the laminate enhancing agents.

12. The method of claim 11, wherein the impregnating comprises impregnating the substrate with about 5 to about 250 grams per square meter of the first thermosetting resin.

13. The method of claim 12, wherein the coating the first side of the substrate comprises coating the substrate with about 5 to about 250 grams per square meter of the slurry.

14. The method of claim 1, further comprising sandwiching a decorative sheet between the overlay and a core sheet to form a unit and applying heat and pressure to the unit.

15. The method of claim 1, wherein the method of forming the overlay further comprises:
applying at least: one or more additional silicone-containing thermoset resin layers and one or more additional layers of slurry to the cured composite to form a second composite; and
curing the second composite.

16. The method of claim 15, wherein an additional silicone-containing thermoset resin layer is applied to the layer of slurry.

17. The method of claim 16, wherein an additional silicone-containing thermoset resin layer is applied to a side of the substrate opposite to the layer of slurry.

18. The method of claim 15, further comprising sandwiching a decorative sheet between the overlay and a core sheet to form a unit and applying heat and pressure to the unit.

19. The method of claim 15, wherein at least one or more of the platelet, platelet, cylindrical, fiber-like shaped laminate enhancing agents are of various lengths and cut at various angles.

20. The method of claim 15, wherein the platelet, platelet, cylindrical, fiber-like shaped laminate enhancing agents comprise an aspect ratio of about 2:1 to about 25:1.

21. The method of claim 15, further comprising preparing the layer of slurry, wherein the layer of slurry comprises about 1 to about 50 percent of the laminate enhancing agents.

22. The method of claim 21, wherein the impregnating comprises impregnating the substrate with about 5 to about 250 grams per square meter of the first thermosetting resin.

23. The method of claim 22, wherein the coating the first side of the substrate comprises coating the substrate with about 5 to about 250 grams per square meter of the slurry.

24. A laminate formed from the method of claim 15.

25. A laminate formed from the method of claim 1.

26. A laminate comprising an overlay, wherein the overlay comprises:
a substrate impregnated with a first silicone based thermoset resin; and
a slurry coating comprising a second silicone based thermoset resin and a mix of laminate enhancing agents, wherein the mix of laminate enhancing agents comprises at least about 5 percent of platelet, platelet, cylindrical, fiber-like shaped particles.

27. The laminate of claim 26, wherein the mix of laminate enhancing agents further comprises crystalline shaped and silicone coated laminate enhancing agents.

28. The laminate of claim 26, wherein at least one or more of the platelet, platelet, cylindrical, fiber-like shaped particles are of various lengths and cut at various angles.

29. The laminate of claim 26, wherein the platelet, platelet, cylindrical, fiber-like shaped laminate enhancing agents comprises at least one of glass, ceramic, and plastic.

30. The laminate of claim 28, wherein the mix of laminate enhancing agents further comprises alumina, silica and titania.

31. The laminate of claim 26, wherein the overlay comprises about 0.1 grams per square meter to about 50 grams per square meter of the laminate enhancing agents.

32. The laminate of claim 26, wherein the laminate enhancing agents comprise a diameter of 10-16 microns and a length of 120-290 microns.

33. The laminate of claim 26, wherein the overlay further comprises at least one of one or more additional silicone-containing thermoset resin layers, and one or more additional layers of slurry.

34. A laminate comprising:
a décor layer comprising:
a décor composite comprising:
a décor sheet comprising a top side opposite to a bottom side, wherein the décor sheet is impregnated with a first silicone based thermoset resin; and
a first coating having a top side opposite to a bottom side, wherein the top side of the first coating is disposed on the top side of the décor sheet, and further wherein the first coating is formed by applying a slurry to the top side of the décor sheet, wherein the slurry comprises a second thermoset resin and a first mix of laminate enhancing agents.

35. The laminate of claim 34, wherein the first mix of laminate enhancing agents comprises platelet, cylindrical, fiber-shaped laminate enhancing agents.

36. The laminate of claim 35, wherein the first mix of laminate enhancing agents further comprises crystalline-shaped silicone coated laminate enhancing agents comprising alumina, silica or titania.

37. The laminate of claim 36, wherein the first mix of laminate enhancing agents comprises at least about 5 percent of the platelet, cylindrical, fiber-shaped laminate enhancing agents based on the total percentage of laminate enhancing agents in the first mix.

38. The laminate of claim 35, wherein the first mix of laminate enhancing agents comprises at least one of glass, ceramic, and plastic.

39. The laminate of claim 35, wherein the cylindrical, fiber-shaped laminate enhancing agents comprise an average particle diameter of about 10 micrometers to about 16 micrometers, and a length of about 120 micrometers to about 290 micrometers.

40. The laminate of claim 35, wherein the platelet, cylindrical, fiber-shaped laminate enhancing agents comprise an aspect ratio of about 2:1 to about 25:1.

41. The laminate of claim 35, wherein the slurry comprises about 1 percent to about 50 percent of the laminate enhancing agents.

42. The laminate of claim 35, wherein the décor sheet comprises about 5 grams per square meter to about 250 grams per square meter of the first silicone based thermoset resin.

43. The laminate of claim 35, wherein the décor layer further comprises one or more additional silicone based thermoset resin-containing layers disposed on the décor composite.

44. The laminate of claim 43, wherein the one or more additional silicone based thermoset resin-containing layers are disposed on the décor composite after the décor composite has been dried and cured.

45. The laminate of claim 44, wherein the one or more additional thermoset resin-containing layers comprises a first silicone based thermoset resin layer disposed on a bottom side of the décor sheet.

46. The laminate of claim 44, wherein the one or more additional silicone based thermoset resin-containing layers comprises a first thermoset resin layer disposed on the bottom side of the first coating.

47. The laminate of claim 46, wherein the one or more additional silicone based thermoset resin-containing layers comprises a second coating comprising a third thermoset resin and a second mix of laminate enhancing agents, and further wherein the second coating is disposed on a side of the first thermoset resin layer opposite to the first coating.

48. The laminate of claim 46, wherein the one or more additional silicone based thermoset resin-containing layers further comprises a second thermoset resin layer disposed between the first thermoset resin layer and the bottom side of the first coating.

49. The laminate of claim 35, further comprising at least one of a base layer and a core, wherein the décor layer is bound to the base layer and/or the core by applying the décor layer to the base layer and/or the core by curing and drying the décor composite and then applying heat and pressure to the décor layer and to the base layer and/or the core.

50. A method for the formation of a laminate, comprising:
providing a décor layer, comprising:
providing a décor composite comprising:
impregnating a décor sheet having a top side opposite to a bottom side with a first silicone based thermoset resin;
applying a first slurry to the top side of the impregnated décor sheet to form a first coating, wherein the slurry comprises a second silicone based thermoset resin and a mix of laminate enhancing agents, wherein the mix of laminate enhancing agents comprises platelet, platelet, cylindrical, fiber-like shaped laminate enhancing agents and crystalline shaped, silicone coated laminate enhancing agents, and further wherein the slurry is applied to the décor sheet such that laminate enhancing agents in the mix are evenly distributed on the décor sheet; and
curing and drying the décor composite;
providing a core; and
bonding the décor layer to the core.

51. The method of claim 50, wherein the core comprises a plurality of prepreg sheets of paper, and wherein bonding the décor layer to the core comprises laminating the plurality of prepreg sheets of paper with the décor layer under heat and pressure.

52. The method of claim 51, wherein one or more of the plurality of prepreg sheets of paper forming the plurality is impregnated with a silicone based thermoset resin.

53. The method of claim 50, wherein the core comprises a plurality of prepreg sheets of paper, and further wherein providing the core comprises impregnating a first sheet from the plurality of prepreg sheets of paper with a third silicone based thermoset resin; and further wherein the bonding the décor layer to the core comprises positioning the first sheet from the plurality of prepreg sheets as an uppermost sheet in the plurality of prepreg sheets and bonding the décor layer to the first sheet.

54. The method of claim 50, wherein the core comprises one or more of particle board or fiber board.

55. The method of claim 50, wherein the platelet, platelet, cylindrical, fiber-like shaped laminate enhancing agents comprise one or more of a glass, a ceramic, and a plastic.

56. The method of claim 55, wherein the crystalline shaped silicone coated laminate enhancing agents comprises alumina, silica or titania.

57. The method of claim 50, wherein the platelet, platelet, cylindrical, fiber-like shaped laminate enhancing agents comprise an average particle diameter of about 10 micrometers to about 16 micrometers, and a length of about 120 micrometers to about 290 micrometers.

58. The method of claim 50, wherein applying the first silicone based slurry comprises:
providing a device comprising:
a container holding the first silicone based slurry, and
a rotating wheel; and
a scraper positioned between the container and the rotating wheel, wherein the scraper is in physical contact with the rotating wheel;
dropping the first silicone based slurry from the container onto the rotating wheel; and
continuously feeding the décor sheet underneath the rotating wheel.

59. The method of claim 50, wherein applying the first silicone based slurry comprises spraying or electrostatically coating the décor sheet.

60. The method of claim 50, wherein providing a décor layer comprises charging the laminate enhancing agents by friction prior to applying the first silicone based slurry to the décor sheet.

61. A method for the formation of a laminate, comprising:
providing a décor composite, comprising:
applying a first mix of laminate enhancing agents to a décor sheet at a printing stage of the décor sheet, wherein the first mix of laminate enhancing agents comprises platelet, platelet, cylindrical, fiber-like shaped laminate enhancing agents;
impregnating the décor sheet with a first silicone based thermoset resin to form an impregnated décor sheet; and
curing and drying the décor sheet;
providing a core; and
bonding the décor layer to the core.

62. The method of claim 61, further comprising providing an overlay, wherein the overlay is disposed over the cured and dried décor sheet.

63. The method of claim 62, wherein providing the overlay comprises impregnating a substrate with a second silicone based thermoset resin composition to form an impregnated substrate, and coating the impregnated substrate with a second slurry, wherein the second slurry comprises a third silicone based thermoset resin composition and a third mix of laminate enhancing agents, wherein the third mix of laminate enhancing agents comprises platelet, cylindrical, fiber-like shaped laminate enhancing agents.

64. The method of claim 63, wherein the third mix of laminate enhancing agents further comprises crystalline shaped silicone coated laminate enhancing agents.

65. The method of claim 61, further comprising applying a first slurry to the impregnated décor sheet, wherein the first slurry comprises a first silicone based thermoset resin composition and a second mix of laminate enhancing agents, wherein the second mix of laminate enhancing agents comprises platelet, cylindrical, fiber-like shaped laminate enhancing agents.

66. The method of claim 65, wherein the first and second mixes of laminate enhancing agents further comprise crystalline shaped silicone coated laminate enhancing agents.

67. The method of claim 65, further comprising providing an overlay, wherein the overlay is disposed over the cured and dried décor sheet.

68. The method of claim 67, wherein providing the overlay comprises impregnating a substrate with a second silicone based thermoset resin composition to faun an impregnated substrate, and coating the impregnated substrate with a second slurry, wherein the second slurry comprises a third silicone based thermoset resin composition and a third mix of laminate enhancing agents, wherein the third mix of laminate enhancing agents comprises platelet, cylindrical, fiber-like shaped laminate enhancing agents.

69. The method of claim 68, wherein the third mix of laminate enhancing agents further comprises crystalline shaped silicone coated laminate enhancing agents.

70. A method for the formation of a laminate, comprising:
providing a décor composite, comprising:
applying a first slurry to a décor sheet at a printing stage of the décor sheet, wherein the first slurry comprises a first silicone based thermoset resin composition and a first mix of laminate enhancing agents comprising platelet, cylindrical, fiber-like shaped laminate enhancing agents;
impregnating the décor sheet with a second silicone based thermoset resin to form an impregnated décor sheet; and
curing and drying the décor sheet;
providing a core; and
bonding the décor layer to the core.

71. The method of claim 70, further comprising providing an overlay, wherein the overlay is disposed over the cured and dried décor sheet.

72. The method of claim 71, wherein providing the overlay comprises impregnating a substrate with a third silicone based thermoset resin composition to form an impregnated substrate, and coating the impregnated substrate with a second slurry, wherein the second slurry comprises a fourth silicone based thermoset resin composition and a second mix of laminate enhancing agents, wherein the second mix of laminate enhancing agents comprises platelet, cylindrical, fiber-like shaped laminate enhancing agents.

73. The method of claim 72, wherein the second mix of laminate enhancing agents further comprises crystalline shaped silicone coated laminate enhancing agents.

74. The method of claim 70, further comprising applying a second slurry to the impregnated décor sheet, wherein the second slurry comprises a second silicone based thermoset resin composition and a second mix of laminate enhancing agents, wherein the second mix of laminate enhancing agents comprises platelet, cylindrical, fiber-like shaped laminate enhancing agents.

75. The method of claim 74, wherein the first and second mixes of laminate enhancing agents further comprise crystalline shaped silicone coated laminate enhancing agents.

76. The method of claim 74, further comprising providing an overlay, wherein the overlay is disposed over the cured and dried décor sheet.

77. The method of claim 76, wherein providing the overlay comprises impregnating a substrate with a third silicone based thermoset resin composition to form an impregnated substrate, and coating the impregnated substrate with a third slurry, wherein the third slurry comprises a third silicone based thermoset resin composition and a third mix of silicone coated laminate enhancing agents, wherein the third mix of laminate enhancing agents comprises platelet, cylindrical, fiber-like shaped laminate enhancing agents.

78. The method of claim 77, wherein the third mix of laminate enhancing agents further comprises crystalline shaped silicone coated laminate enhancing agents.
